(19) United States
(12) Patent Application Publication
(10) Pub. No.: US 2026/0235924 A1
(43) Pub. Date: Aug. 13, 2026

(54) CAMERA ACTUATOR AND CAMERA MODULE COMPRISING SAME

(71) Applicant: LG INNOTEK CO., LTD., Seoul (KR)

(72) Inventor: Sung Guk LEE, Seoul (KR)

(21) Appl. No.: 19/157,615

(22) PCT Filed: Feb. 5, 2024
(86) PCT No.: PCT/KR2024/095072

§ 371 Date: Aug. 18, 2025

(30) Foreign Application Priority Data
Feb. 16, 2023 (KR) 10-2023-0020538
Feb. 16, 2023 (KR) 10-2023-0020539

(51) Int. Cl. G03B 5/00; G03B 17/17

(52) U.S. Cl. CPC G03B 5/00; G03B 17/17

(57) ABSTRACT

Disclosed in an embodiment of the present invention is a camera actuator comprising: a housing; a mover which is arranged in the housing, and which includes a holder and an optical member arranged in the holder; a driving unit for moving the mover; a coupling member, which penetrates the housing and is coupled to the holder; a tilting guide unit arranged between the housing and the mover so as to guide tilting of the mover; and an elastic member arranged between the coupling member and the housing, wherein the elastic member presses the tilting guide unit on the mover.

### CROSS-REFERENCE TO RELATED APPLICATIONS

This application is the U.S. national stage application of International Patent Application No. PCT/KR2024/095072, filed Feb. 5, 2024, which claims the benefit under 35 U.S.C. § 119 of Korean Application Nos. 10-2023-0020538, filed Feb. 16, 2023; and 10-2023-0020539, filed Feb. 16, 2023; the disclosures of each of which are incorporated herein by reference in their entirety.

### TECHNICAL FIELD

The present invention relates to a camera actuator and a camera module including the same.

### BACKGROUND ART

Cameras are devices which capture photos or videos of subjects and are installed in portable devices, drones, vehicles, and the like. Camera modules may have an image stabilization (IS) function of correcting or inhibiting the image shaking caused by a user's movement, an auto-focus function of automatically adjusting a gap between an image sensor and a lens to align the focal length of the lens, and a zoom function of increasing or decreasing the magnification of a distant subject to take a picture using a zoom lens to improve the quality of the images.

However, when performing anti-shake functions and the like in camera modules, a structure in which the influence of the magnetic force due to a magnet or the like is minimized is required.

In addition, there is a problem of optical performance deterioration due to foreign matter in camera modules, and thus a solution for solving this problem is required.

### Disclosure

### Technical Problem

A technical problem to be solved by the present invention is to provide a camera actuator and a camera device that facilitate design and suppress the generation of an electromagnetic force by performing pressing of a tilting guide unit through an elastic member.

The present invention may provide a camera actuator and a camera device with improved reliability by absorbing impacts and suppressing the detachment of a protruding portion through a pad and an additional boss.

Embodiments according to the present invention may provide a camera actuator and a camera device with improved reliability by suppressing the inflow of foreign matter through a plate.

Embodiments according to the present invention may provide a camera actuator and a camera device applicable to ultra-slim, ultra-small, and high-resolution cameras.

In addition, a technical problem to be solved by embodiments of the present invention is to provide a camera actuator and a camera module that inhibit optical performance deterioration by arranging a trap unit that captures foreign matter or particles in a component.

Embodiments of the present invention may provide a camera actuator and a camera module that inhibit foreign matter (or particles) from being introduced into a filter (glass), image sensor, or lens through the trap unit and a protrusion (for example, a jaw) structure, and block overflow of a solution.

Embodiments of the present invention are to provide a camera actuator applicable to ultra-slim, ultra-small, and high-resolution cameras.

The problems to be solved by the embodiments are not limited thereto, and purposes or effects which may be grasped from solutions or embodiments of the problems to be described below are also included.

### Technical Solution

A camera actuator according to an embodiment of the present invention includes: a housing; a mover disposed in the housing and including a holder and an optical member disposed in the holder; a driving unit configured to move the mover; a coupling member that passes through the housing and is coupled to the holder; a tilting guide unit disposed between the housing and the mover to guide tilting of the mover; and an elastic member disposed between the coupling member and the housing, and the elastic member presses the tilting guide unit to the mover.

The mover may be rotatable in at least one of a first direction and a second direction.

The coupling member may include a member base portion, a first extension portion extending from one end of the member base portion toward the holder, and a second extension portion extending from the other end of the member base portion toward the holder.

The coupling member may include a first groove disposed in an inner surface of the member base portion.

The housing may include a housing side portion facing the member base portion, and the housing side portion may include a first through hole and a second through hole.

The first extension portion may pass through the first through hole, and the second extension portion may pass through the second through hole.

The first groove may be disposed between the first through hole and the second through hole and may overlap the first through hole and the second through hole in the second direction.

The elastic member may include a first elastic member and a second elastic member disposed spaced apart from each other in the second direction, and the first elastic member and the second elastic member may be disposed between the first through hole and the second through hole.

The housing side portion may include a second groove facing the first groove, and the elastic member may be disposed in the first groove and the second groove.

The second groove may overlap the first groove in a third direction perpendicular to the first direction and the second direction.

The first groove may be partially offset from the second groove in the third direction perpendicular to the first direction and the second direction.

The first groove may be located below a line bisecting the coupling member in the first direction.

The first groove may overlap the line bisecting the coupling member in the first direction.

The tilting guide unit may include a base, a first protruding portion spaced apart in the first direction on one surface of the base, and a second protruding portion spaced apart in the second direction on the other surface of the base, and the first groove and the second groove may overlap the second protruding portion in the third direction.

The first protruding portion may protrude from the base toward the mover, and the second protruding portion may protrude toward the housing side portion.

A camera actuator according to an embodiment of the present invention includes: a fixed assembly; a housing connected to the fixed assembly; a first lens assembly and a second lens assembly moving in an optical axis direction in the housing; and a driving unit configured to move the first lens assembly and the second lens assembly, in which the first lens assembly is disposed between the second lens assembly and the fixed assembly, and the fixed assembly includes an assembly hole, an upper surface groove configured to overlap the assembly hole in a horizontal direction, and a lower surface groove configured to overlap the upper surface groove in a vertical direction.

The upper surface groove and the lower surface groove may be offset in the optical axis direction.

The fixed assembly may include an upper surface jaw portion disposed at an edge of the upper surface groove.

The fixed assembly may include a fixed protrusion portion configured to protrude outward from the fixed assembly, and the fixed protrusion portion may have a height greater than that of the upper surface jaw portion.

The housing may include an inner bottom surface having a bottom surface hole, and a trap unit disposed on the inner bottom surface of the housing.

The housing may include a bottom surface jaw portion disposed adjacent to the bottom surface hole.

The housing may include a trap groove disposed in at least one of facing inner surfaces in a vertical direction of the housing.

The camera actuator may include a guide unit disposed adjacent to a side portion of the housing, the trap unit may be provided as a plurality of trap units, any one of the trap units may overlap the guide unit in a vertical direction, and another thereof may overlap any one of the first lens assembly and the second lens assembly in the vertical direction.

The camera actuator may include a board unit disposed on a side portion of the housing, and the housing may include an outer surface protrusion configured to protrude in the optical axis direction and come into contact with the board unit.

An outer surface of the housing may include an outer surface groove disposed adjacent to the outer surface protrusion.

The camera actuator may include a guide unit disposed adjacent to a side portion of the housing, and the guide unit may include a first guide groove and a second guide groove in which balls are seated; and a connecting portion configured to connect the first guide groove and the second guide groove.

The connecting portion may include a guide recess disposed in an inner surface thereof.

The guide recess may be disposed on an outer side of the first guide groove and the second guide groove.

The first lens assembly may include a first lens holder in which a lens is accommodated, and a first wing portion disposed between the first lens holder and the housing and having a recess.

The first wing portion may include a trap unit disposed on an inner surface thereof.

### Advantageous Effects

According to embodiments of the present invention, a camera actuator and a camera device that facilitate design and suppress the generation of an electromagnetic force can be implemented by performing pressing of a tilting guide unit through an elastic member.

Embodiments of the present invention can implement a camera actuator and a camera device with improved reliability by absorbing impacts and suppressing the detachment of a protruding portion through a pad and an additional boss.

Embodiments according to the present invention can implement a camera actuator and a camera device with improved reliability by suppressing the inflow of foreign matter through a plate.

In addition, according to embodiments of the present invention, a technical problem to be solved can implement a camera actuator and a camera module that inhibit optical performance deterioration by arranging a trap unit that captures foreign matter or particles in a component.

Embodiments of the present invention can implement a camera actuator and a camera module that inhibit foreign matter (or particles) from entering a filter (glass), image sensor, or lens through the trap unit and a protrusion (for example, a jaw) structure, and inhibit a solution from overflowing.

Embodiments of the present invention can implement a camera actuator applicable to ultra-slim, ultra-small, and high-resolution cameras.

Various useful advantages and effects of the present invention are not limited to the above-described contents, and can be more easily understood in a process of describing specific embodiments of the present invention.

### DESCRIPTION OF DRAWINGS

FIG. 1 is a perspective view of a camera module according to an embodiment.

FIG. 2 is an exploded perspective view of the camera module according to the embodiment.

FIG. 3 is a cross-sectional view along line AA′ in FIG. 1.

FIG. 4 is a perspective view of a first camera actuator according to the embodiment.

FIG. 5 is an exploded perspective view of the first camera actuator according to the embodiment.

FIG. 6A is a perspective view of a housing of the first camera actuator according to the embodiment.

FIG. 6B is a perspective view in a direction different from that of FIG. 6A.

FIG. 6C is a front view of the housing of the first camera actuator according to the embodiment.

FIG. 7 is a perspective view of an optical member of the first camera actuator according to the embodiment.

FIG. 8A is a perspective view of a holder of the first camera actuator according to the embodiment.

FIG. 8B is a bottom view of the holder of the first camera actuator according to the embodiment.

FIG. 8C is a front view of the holder of the first camera actuator according to the embodiment.

FIG. 8D is another perspective view of the holder of the first camera actuator according to the embodiment.

FIG. 8E is a cross-sectional view along line II′ in FIG. 8D.

FIG. 8F is a rear view of a coupling member of the first camera actuator according to the embodiment.

FIG. 8G is a bottom view of the coupling member of the first camera actuator according to the embodiment.

FIG. 9A is a perspective view of a tilting guide unit of the first camera actuator according to the embodiment.

FIG. 9B is a perspective view in a direction different from that of FIG. 9A.

FIG. 9C is a cross-sectional view along line FF′ in FIG. 9A.

FIG. 10 is a view showing a driving unit of the first camera actuator according to the embodiment.

FIG. 11A is a perspective view of the first camera actuator according to the embodiment.

FIG. 11B is a cross-sectional view along line PP′ in FIG. 11A.

FIG. 11C is a cross-sectional view along line QQ′ in FIG. 11A.

FIG. 12A is a perspective view of the first camera actuator according to the embodiment.

FIG. 12B is a cross-sectional view along line SS′ in FIG. 12A.

FIG. 12C is a view showing an example of movement of the first camera actuator shown in FIG. 12B.

FIG. 13A is a cross-sectional view along line RR′ in FIG. 12A.

FIG. 13B is a view showing an example of movement of the first camera actuator shown in FIG. 13A.

FIG. 14 is a cross-sectional view of a first camera actuator according to another embodiment.

FIG. 15 is a cross-sectional view of a first camera actuator according to still another embodiment.

FIG. 16 is a perspective view of a second camera actuator according to the embodiment.

FIG. 17 is a cross-sectional view along line DD′ in FIG. 16.

FIG. 18 is a schematic diagram showing a circuit board according to the embodiment.

FIG. 19 is a perspective view of a camera module according to the embodiment.

FIG. 20 is an exploded perspective view of the camera module according to the embodiment.

FIG. 21 is a view along line AA′ in FIG. 19.

FIG. 22 is a perspective view of the second camera actuator according to the embodiment.

FIG. 23 is an exploded perspective view of the second camera actuator according to the embodiment.

FIG. 24 is a view along line DD′ in FIG. 22.

FIGS. 25, 26, and 27 are perspective views of a second housing in the second camera actuator according to the embodiment.

FIGS. 28 and 29 are views for describing each driving of a lens assembly according to the embodiment.

FIG. 30 is a view for describing the driving of the second camera actuator according to the embodiment.

FIG. 31 is a perspective view of a fixed assembly in the second camera actuator according to the embodiment.

FIG. 32 is a bottom view of the fixed assembly in the second camera actuator according to the embodiment.

FIG. 33 is a cross-sectional view along line BB′ in FIG. 31.

FIG. 34 is a side view of a housing in the second camera actuator according to the embodiment.

FIG. 35 is a perspective view of the housing in the second camera actuator according to the embodiment.

FIG. 36 is another perspective view of the housing in the second camera actuator according to the embodiment.

FIG. 37 is a perspective view of the housing, a lens assembly, a driving unit, and a guide unit in the second camera actuator according to the embodiment.

FIG. 38 is a bottom view of the second camera actuator according to the embodiment.

FIG. 39 is an enlarged cross-sectional view of the second camera actuator according to the embodiment.

FIG. 40 is a perspective view of the guide unit of the second camera actuator according to the embodiment.

FIG. 41 is a perspective view of a first lens assembly and a second lens assembly in the second camera actuator according to the embodiment.

FIG. 42 is another perspective view of the first lens assembly and the second lens assembly in the second camera actuator according to the embodiment.

FIG. 43 is a schematic view showing a circuit board according to an embodiment.

FIG. 44 is a perspective view of a mobile terminal to which the camera module according to the embodiment is applied.

FIG. 45 is a perspective view of a vehicle to which the camera module according to the embodiment is applied.

### MODES OF THE INVENTION

Since the embodiments according to the present invention may have various modifications and embodiments, specific embodiments are exemplified in the drawings and described. Here, this is not intended to limit the present invention to specific embodiments, and it should be understood to include all modifications, equivalents, or substitutes included in the spirit and technical scope of the present invention.

Although terms that include ordinal numbers such as second and first may be used for describing various constituent elements, the constituent elements are not limited by these terms. These terms are used only for distinguishing one constituent element from another. For example, without departing from the scope of the present invention, a second constituent element could be named a first constituent element, and similarly, the first constituent element could also be named the second constituent element. The term and/or includes any combination of a plurality of related described items or any item among the plurality of related described items.

When it is said that a constituent element is “connected” or “coupled” to another constituent element, although it should be understood that it may be directly connected or coupled to that other constituent element, another constituent element may also be present therebetween. On the other hand, when it is said that any constituent element is “directly connected” or “directly coupled” to another constituent element, it should be understood that another constituent element is not present therebetween.

The terminology used in the present application is used only for describing specific embodiments and is not intended to limit the present invention. Singular expressions include plural expressions unless the context clearly indicates otherwise. In the present application, it should be understood that terms such as terms “include” or “have” are intended to specify the presence of a feature, a number, a step, an operation, a constituent element, a part or a combination thereof described in the specification, but do not exclude in advance the possibility of the presence or the addition of one or more of other features, numbers, steps, operations, constituent elements, parts or combinations thereof.

Unless otherwise defined, all terms used herein, including technical or scientific terms, have the same meaning as commonly understood by one of ordinary skill in the art to which this invention belongs. Terms defined in commonly used dictionaries should be interpreted as having a meaning consistent with their meaning in the context of the relevant art, and will not be interpreted in an idealized or overly formal sense, unless expressly defined otherwise in the present application.

Hereinafter, embodiments will be described in detail with reference to the attached drawings. Regardless of the drawing number, the same or corresponding constituent elements are denoted by the same reference numerals and redundant descriptions thereof will be omitted.

Additionally, in this specification, a camera actuator is described as a device that moves a lens, but includes both concepts in which the device includes or does not include a lens. In the following description, first and second camera actuators are described to include a concept in which each of the first and second camera actuators includes a lens. Additionally, a camera actuator that moves a lens may also be referred to as a ‘lens transfer device’ or a ‘lens driving device.’

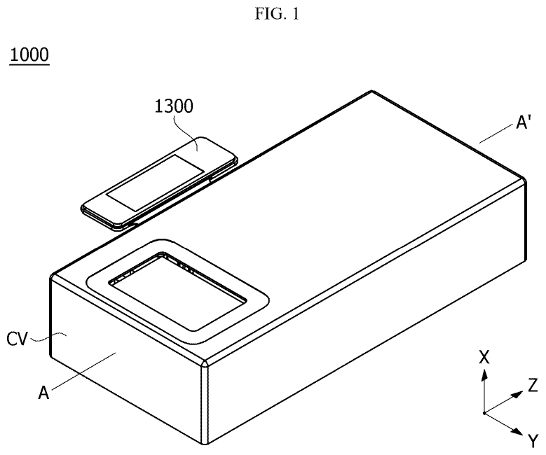

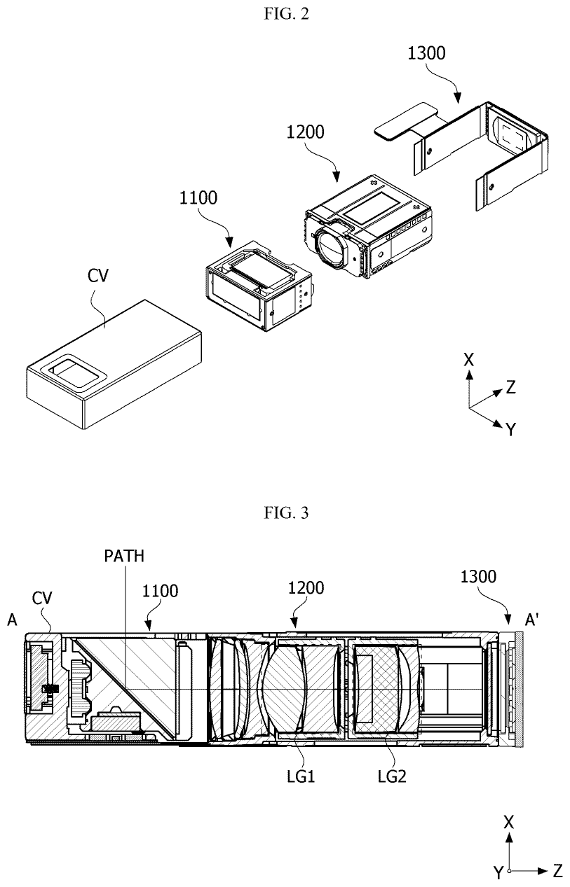

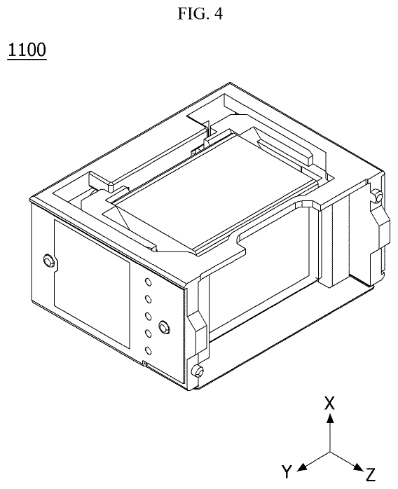

FIG. 1 is a perspective view of a camera module according to an embodiment, FIG. 2 is an exploded perspective view of the camera module according to the embodiment, and FIG. 3 is a cross-sectional view along line AA′ in FIG. 1.

Referring to FIGS. 1 and 2, a camera module 1000 according to an embodiment may be composed of a cover CV, a first camera actuator 1100, a second camera actuator 1200, and a circuit board 1300. Here, the first camera actuator 1100 may be used interchangeably with a first actuator and the second camera actuator 1200 may be used interchangeably with a second actuator.

The cover CV may cover the first camera actuator 1100 and the second camera actuator 1200. A coupling force between the first camera actuator 1100 and the second camera actuator 1200 may be improved by the cover CV.

Furthermore, the cover CV may be made of a material that performs electromagnetic shielding. Thus, the first camera actuator 1100 and the second camera actuator 1200 in the cover CV may be easily protected.

Further, the first camera actuator 1100 may be an optical image stabilization (OIS) actuator. For example, the first camera actuator 1100 may move an optical member in a direction perpendicular to an optical axis (an axis of incident light).

The first camera actuator 1100 may include a fixed focal length lens disposed in a predetermined barrel (not shown). The fixed focal length lens may also be referred to as a “single focal length lens” or a “prime lens.”

The first camera actuator 1100 may change an optical path. In an embodiment, the first camera actuator 1100 may vertically change the optical path through an internal optical member (for example, a prism or a mirror). For example, the optical member may change a direction of light from a first direction (X-axis direction) to a third direction (Z-axis direction). With this configuration, a configuration of lenses having sizes greater than a thickness of a mobile terminal may be disposed in the mobile terminal to perform magnification, auto-focus (AF), zoom, and OIS functions, even though the thickness of the mobile terminal is reduced, by changing the optical path.

However, the present invention is not limited thereto and the first camera actuator 1100 may change the optical path vertically or at a predetermined angle multiple times.

The second camera actuator 1200 may be disposed at a rear end of the first camera actuator 1100. The second camera actuator 1200 may be coupled to the first camera actuator 1100. Further, the second camera actuator 1200 and the first camera actuator 1100 may be coupled in various ways.

Furthermore, the second camera actuator 1200 may be a zoom actuator or an AF actuator. For example, the second camera actuator 1200 may support one or a plurality of lenses LG1 and LG2 and move the lenses in response to a control signal from a predetermined control unit to perform an auto-focus function or a zoom function.

Further, one or the plurality of lenses LG1 and LG2 may move independently or individually in an optical axis direction.

The circuit board 1300 may be disposed at a rear end of the second camera actuator 1200. The circuit board 1300 may be electrically connected to the second camera actuator 1200 and the first camera actuator 1100. Moreover, a plurality of circuit boards 1300 may be provided.

The camera module according to the embodiment may be composed of one or a plurality of camera modules. For example, the plurality of camera modules may include a first camera module and a second camera module.

Further, one camera module may include one or a plurality of actuators. For example, one camera module may include the first camera actuator 1100 and the second camera actuator 1200.

Further, the camera module may be disposed in a predetermined housing (not shown) and may include an actuator (not shown) capable of driving a lens unit. The actuator may be a voice coil motor, a micro actuator, a silicon actuator, or the like and applied in various ways such as capacitive, thermal, bimorph, and electrostatic methods, but is not limited thereto. In addition, in this specification, the camera actuator may be referred to as an actuator or the like. In addition, a camera module composed of a plurality of camera modules may be installed in various electronic devices, such as mobile terminals. Furthermore, the actuator may be a device for moving or tilting a lens and an optical member. However, in the following description, the actuator is described as a concept in which the actuator includes a lens or an optical member. Furthermore, the actuator may be referred to as a ‘lens transfer device,’ a ‘lens movement device,’ an ‘optical member transfer device,’an ‘optical member movement device,’ or the like.

Referring to FIG. 3, the camera module according to the embodiment may include the first camera actuator 1100 that performs an OIS function and the second camera actuator 1200 that performs zoom and AF functions.

Light may be incident into the camera module or the first camera actuator through an opening region located in an upper surface of the first camera actuator 1100. That is, light may be incident into the first camera actuator 1100 in the optical axis direction (for example, an X-axis direction, based on incident light), and the optical path may be changed in a vertical direction (for example, a Z-axis direction) through the optical member. Further, light may pass through the second camera actuator 1200 and may be incident on an image sensor IS located at one end of the second camera actuator 1200 (PATH). In this specification, the Z-axis direction or the third direction is described as the optical axis direction as follows.

In this specification, a bottom surface means one side in the first direction. Further, the first direction is the X-axis direction in the drawings and may be used interchangeably with a second-axis direction or the like. The second direction is a Y-axis direction in the drawings and may be used interchangeably with a first-axis direction or the like. The second direction is a direction perpendicular to the first direction. Also, the third direction is the Z-axis direction in the drawings and may be used interchangeably with a third-axis direction or the like. Further, the third direction is a direction perpendicular to both the first and second directions. Here, the third direction (Z-axis direction) corresponds to a direction of the optical axis, and the first direction (X-axis direction) and the second direction (Y-axis direction) are directions perpendicular to the optical axis. Additionally, in the following description, in the description of the first camera actuator and the second camera actuator, the optical axis direction is the third direction (Z-axis direction), and the following description is made based on this.

Furthermore, in this specification, an inner side may be a side in a direction from the cover CV toward the first camera actuator, and an outer side may be a side in a direction opposite to that of the inner side. For example, the first camera actuator and the second camera actuator may be located inside the cover CV, and the cover CV may be located outside the first camera actuator or the second camera actuator.

The camera module according to the embodiment may improve the spatial limitations of the first camera actuator and the second camera actuator by changing the optical path. The camera module according to the embodiment may expand the optical path while minimizing the thickness of the camera module in response to a change in the optical path. Furthermore, it should be understood that the second camera actuator can also provide a high range of magnification by controlling a focus or the like in the expanded optical path.

Furthermore, the camera module according to the embodiment can implement OIS through control of the optical path via the first camera actuator, thereby minimizing the occurrence of decentering or tilt phenomena and producing the best optical characteristics.

Further, the second camera actuator 1200 may include an optical system and a lens driving unit. For example, at least one of a first lens assembly, a second lens assembly, and a third lens assembly may be disposed in the second camera actuator 1200.

In addition, the second camera actuator 1200 may have a coil and a magnet to perform a high magnification zoom function and an auto-focus function.

For example, the first lens assembly and the second lens assembly may be moving lenses that move via coils, magnets, and guide pins, and the third lens assembly may be a fixed lens, but is not limited thereto. For example, the third lens assembly may function as a focator that forms an image by focusing light on a specific position and have a significant change in magnification due to a significant change in a distance to a subject or an image distance depending on the movement of the first lens assembly. Further, the first lens assembly, which is a variator, may play an important role in the focal length or magnification change of the optical system. Meanwhile, an image point that is formed in the first lens assembly, which is a variator, may vary slightly depending on the position thereof. Thus, the second lens assembly may perform a position compensation function for the image formed using the variator. For example, the second lens assembly may function as a compensator, which functions to accurately form the image point formed in the first lens assembly, which is a variator, on an actual position of the image sensor.

Further, the first lens assembly and the second lens assembly may be driven using an electromagnetic force due to the interaction of the coils and the magnets. The above description can be applied to the lens assembly which will be described below. Furthermore, the first lens assembly and the second lens assembly may move in the optical axis direction, that is, the third direction. Further, the first lens assembly and the second lens assembly may move in the third direction independently or dependently.

Furthermore, the third lens assembly may be located at a front end of the first lens assembly or at a rear end of the second lens assembly. That is, the third lens assembly may be positioned adjacent to the first camera actuator or adjacent to the image sensor. Further, the third lens assembly may be fixed.

In the present invention, the first lens assembly and the second lens assembly may move in the optical axis direction. Further, the third lens assembly may be located at a front end of the first lens assembly or at a rear end of the second lens assembly. Further, the third lens assembly may not move in the optical axis direction. That is, the third lens assembly may be a fixed unit. Furthermore, the first and second lens assemblies may be moving units.

Meanwhile, when an actuator for OIS and an actuator for AF/zoom are disposed in accordance with the embodiment of the present invention, magnetic interference with a magnet for AF/zoom may be inhibited when driving the OIS. Since a magnet of the first camera actuator 1100 is disposed separately from the second camera actuator 1200, magnetic interference between the first camera actuator 1100 and the second camera actuator 1200 may be inhibited. In this specification, OIS may be interchangeably referred to as the terms such as image stabilization, optical image stabilization, optical image correction, and shake correction.

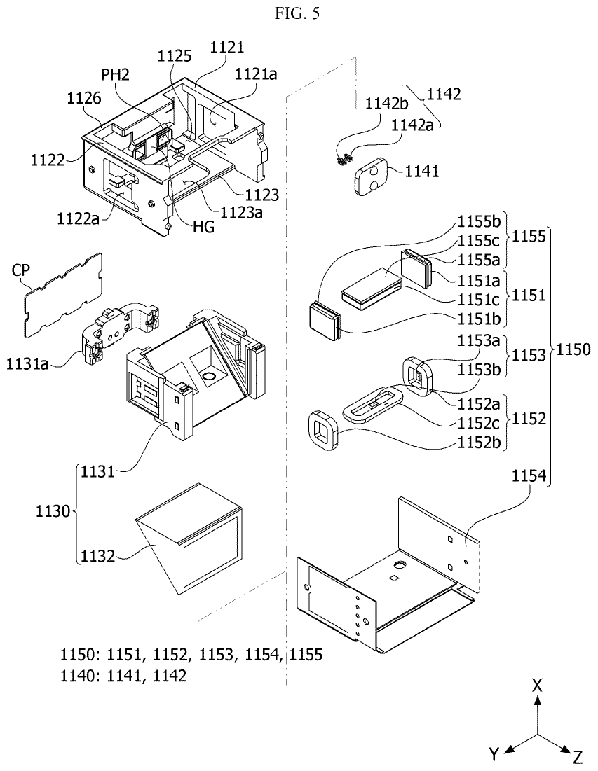

FIG. 4 is a perspective view of the first camera actuator according to the embodiment, and FIG. 5 is an exploded perspective view of the first camera actuator according to the embodiment.

Referring to FIGS. 4 and 5, the first camera actuator 1100 according to the embodiment includes a housing 1120, a mover 1130, a rotating unit 1140, a driving unit 1150, a sixth housing side portion 1126, and a coupling member 1131a. Furthermore, the first camera actuator 1100 may further include a plate CP.

The mover 1130 may include a holder 1131 and an optical member 1132 seated in the holder 1131. Further, the rotating unit 1140 may include a tilting guide unit 1141 and an elastic member 1142 for pressing the tilting guide unit 1141. Additionally, the driving unit 1150 may include a driving magnet 1151, a driving coil 1152, a Hall sensor unit 1153, a board unit 1154, and a yoke unit 1155.

First, the first camera actuator 1100 may include a shield can (not shown). The shield can (not shown) may be located at the outermost side of the first camera actuator 1100 and may be located to surround the rotating unit 1140 and the driving unit 1150 described below.

The shield can (not shown) may block or reduce electromagnetic waves generated from the outside. That is, the shield can (not shown) may reduce the occurrence of malfunction in the rotating unit 1140 or the driving unit 1150.

The housing 1120 may be located inside the shield can (not shown). In the absence of the shield can, the housing 1120 may be located at the outermost side of the first camera actuator.

Furthermore, the housing 1120 may be located inside the board unit 1154 described below. The housing 1120 may be fitted into or aligned with the shield can (not shown) and may be fastened.

The housing 1120 may include a first housing side portion 1121, a second housing side portion 1122, a third housing side portion 1123, and a fourth housing side portion 1124. A detailed description thereof will be made below.

The sixth housing side portion 1126 may be disposed in the housing 1120. The sixth housing side portion 1126 may be disposed between the coupling member 1131a and the housing. The sixth housing side portion 1126 may be disposed in the housing 1120 or may be included in the housing 1120. A detailed description thereof will be made below.

The mover 1130 may include the holder 1131 and the optical member 1132 seated in the holder 1131.

Furthermore, the first camera actuator 1100 may further include the plate CP disposed on an outer side of the housing 1120 or the coupling member 1131a. The plate CP may inhibit foreign matter from entering the coupling member 1131a or the like passing through the sixth housing side portion 1126. Furthermore, the plate CP may be made of a magnetic material. Accordingly, the plate CP may have magnetism and reduce a magnetic force generated by the driving unit. When the plate CP is a magnetic body, the plate CP may be referred to as a magnetic member, a magnetic body, a cover plate, a metal member, a metal plate, or the like. Additionally, the plate CP may be made of a non-magnetic material for weight reduction and low cost.

The holder 1131 may be seated in an accommodating portion 1125 of the housing 1120. The holder 1131 may include a first holder outer surface to a fourth holder outer surface corresponding to the first housing side portion 1121, the second housing side portion 1122, the third housing side portion 1123, and the sixth housing side portion 1126, respectively. For example, the first holder outer surface to the fourth holder outer surface may correspond to or face inner surfaces of the first housing side portion 1121, the second housing side portion 1122, the third housing side portion 1123, and the sixth housing side portion 1126, respectively.

Additionally, the holder 1131 may include the coupling member 1131a disposed in a fourth seating groove. A detailed description thereof will be made below.

The optical member 1132 may be seated in the holder 1131. For this purpose, the holder 1131 may have a seating surface, and the seating surface may be formed by an accommodating groove. In an embodiment, the optical member 1132 may be formed of a mirror or prism. Although the following description is made based on the optical member 1132 being formed of a prism, the optical member may also be formed of a plurality of lenses as in the above-described embodiment. Alternatively, the optical member 1132 may be formed of a plurality of lenses and prisms or mirrors. Further, the optical member 1132 may include a reflecting unit disposed therein. Here, the present invention is not limited thereto.

Additionally, the optical member 1132 may reflect light reflected from the outside (for example, an object) into the camera module. In other words, the optical member 1132 may improve the spatial limitations of the first camera actuator and the second camera actuator by changing a path of reflected light. Thus, it should be understood that the camera module can provide a high range of magnification by expanding the optical path while minimizing the thickness thereof.

Additionally, the coupling member 1131a may be coupled to the holder 1131. The coupling member 1131a may be disposed outside the holder 1131 and inside the housing 1120. Further, the coupling member 1131a may be seated in an additional groove located in a region other than the fourth seating groove in the fourth holder outer surface in the holder 1131. Through this, the coupling member 1131a may be coupled to the holder 1131, and at least a part of the sixth housing side portion 1126 may be located between the coupling member 1131a and the holder Substitute Specification-Clean 1131. For example, at least a part of the sixth housing side portion 1126 may pass through a space formed between the coupling member 1131a and the holder 1131.

Additionally, the coupling member 1131a may be formed as a separate structure from the holder 1131. With this configuration, the assembly of the first camera actuator can be easily performed as described below. Alternatively, the coupling member 1131a may be formed integrally with the holder 1131, but is described below as a separate structure.

The rotating unit 1140 may include the tilting guide unit 1141 and the elastic member 1142 that provides an elastic restoring force to press the tilting guide unit 1141.

The elastic member 1142 may press the tilting guide unit 1141 to the mover 1130. Further, the tilting guide unit 1141 may guide the tilting of the mover 1130.

The tilting guide unit 1141 may be coupled to the mover 1130 and the housing 1120 described above. Specifically, the tilting guide unit 1141 may be disposed between the holder 1131 and the sixth housing side portion 1126. Accordingly, the tilting guide unit 1141 may be coupled to the mover 1130 of the holder 1131 and the housing 1120. However, unlike the above-described contents, in this embodiment, the tilting guide unit 1141 may be disposed between the sixth housing side portion 1126 and the holder 1131. Specifically, the tilting guide unit 1141 may be located between the sixth housing side portion 1126 and the fourth seating groove of the holder 1131.

The coupling member 1131a, the sixth housing side portion 1126, the tilting guide unit 1141, and the holder 1131 may be disposed in this order in the third direction (Z-axis direction). Additionally, the elastic member 1142 may be seated in a first groove gr1 formed in the coupling member 1131a and a second groove formed in the sixth housing side portion 1126. That is, the first groove and the second groove may be located inside the coupling member 1131a or inside the sixth housing side portion 1126. A coupling member may be applied to the first groove gr1 and the second groove gr2 so that the first groove gr1 and the second groove gr2 are coupled to the elastic member 1142. Additionally, a coupling member may not be applied to the first groove gr1 and the second groove gr2 so that the first groove gr1 and the second groove gr2 are coupled to the elastic member 1142.

In this embodiment, the first groove gr1 may be located in the coupling member 1131a and may move integrally with the holder, and the second groove may be located in the sixth housing side portion 1126 to correspond to the first groove gr1 and may be coupled to the housing 1120.

Additionally, the tilting guide unit 1141 may be disposed adjacent to the optical axis. Accordingly, the actuator according to the embodiment may easily change the optical path in accordance with the first and second axis tilts described below.

The tilting guide unit 1141 may include first protruding portions disposed spaced apart in the first direction (X-axis direction) and second protruding portions disposed spaced apart in the second direction (Y-axis direction). Additionally, the first protruding portions and the second protruding portions may protrude in opposite directions. A detailed description thereof will be made below.

Additionally, as described above, the elastic member 1142 may be disposed between the housing 1120 and the coupling member 1131a. Further, the elastic member 1142 may cause the mover 1130 to press the tilting guide unit 1141 through an elastic restoring force. Further, the mover 1130 may rotate in the first direction (X-axis direction) and/or the second direction (Y-axis direction).

The sixth housing side portion 1126 may be a member separated from the housing 1120 or may be a member coupled to the housing 1120 as shown in the drawing. A structure in which the sixth housing side portion 1126 is coupled in the housing 1120 will be described below.

The elastic member 1142 may generate an elastic restoring force between the mover 1130 and the sixth housing side portion. This elastic restoring force may be applied to the holder 1131 or the coupling member 1131a coupled to one end of the elastic member 1142 and the housing 1120 or the sixth housing side portion 1126 coupled to the other end of the elastic member 1142. At this time, the elastic restoring force applied to the coupling member 1131a may be transmitted to the holder 1131 coupled to the coupling member 1131a. Thus, the tilting guide unit 1141 disposed between the coupling member 1131a and the sixth housing side portion 1126 may be pressed by the elastic restoring force. That is, the elastic restoring force may maintain the tilting guide unit 1141 located between the holder 1131 and the housing 1120 (or the sixth housing side portion 1126). With this configuration, the position between the mover 1130 and the housing 1120 may be maintained even when tilting with respect to an X-axis or a Y-axis. Additionally, the tilting guide unit may be brought into close contact with the sixth housing side portion 1126 and the holder 1131 by the elastic restoring force.

The driving unit 1150 may include the driving magnet 1151, the driving coil 1152, the Hall sensor unit 1153, the board unit 1154, and the yoke unit 1155. Details regarding this will be described below.

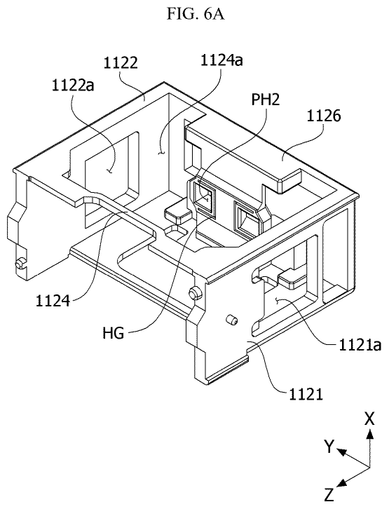

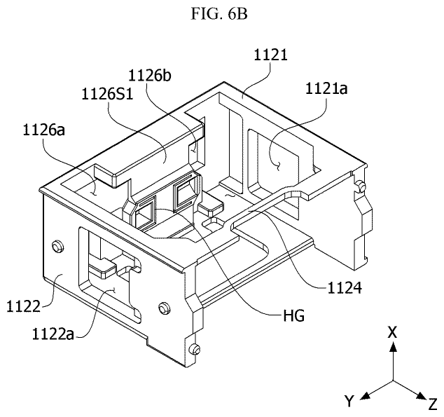

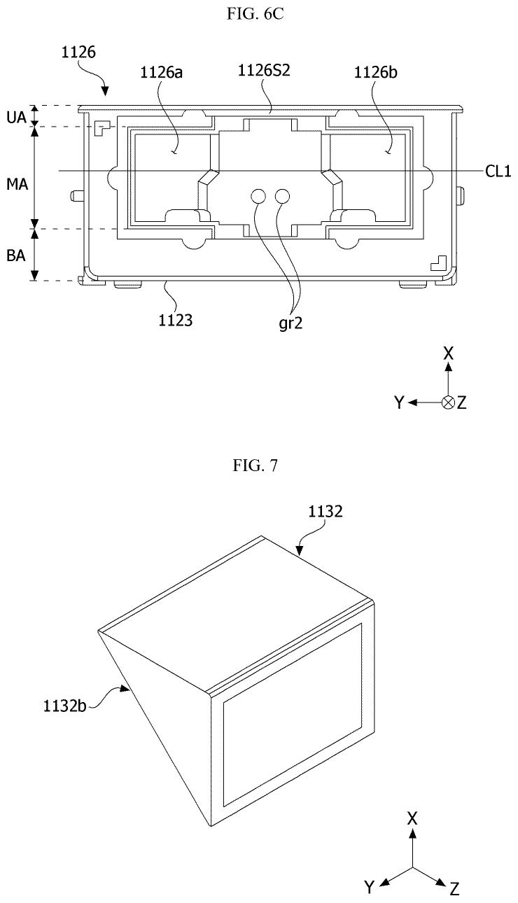

FIG. 6A is a perspective view of a housing of the first camera actuator according to the embodiment, FIG. 6B is a perspective view in a direction different from that of FIG. 6A, and FIG. 6C is a front view of the housing of the first camera actuator according to the embodiment.

Referring to FIGS. 6A to 6C, the housing 1120 according to the embodiment may include the first housing side portion 1121 to the fourth housing side portion 1124. Additionally, the sixth housing side portion 1126 may be coupled to the housing 1120 and formed integrally with the housing 1120. Accordingly, the sixth housing side portion 1126 may be configured to be included in the housing 1120. That is, the housing 1120 may be formed integrally by being coupled to the sixth housing side portion 1126. Alternatively, the housing 1120 may include the sixth housing side portion 1126.

The first housing side portion 1121 and the second housing side portion 1122 may be disposed to face each other. Additionally, the third housing side portion 1123 and the fourth housing side portion 1124 may be disposed to face each other.

Further, the third housing side portion 1123 and the fourth housing side portion 1124 may be disposed between the first housing side portion 1121 and the second housing side portion 1122.

The third housing side portion 1123 and the fourth housing side portion 1124 may be in contact with the first housing side portion 1121 and the second housing side portion 1122. Further, the third housing side portion 1123 may be a bottom surface in the housing 1120. Further, the fourth housing side portion 1124 may be an upper surface in the housing 1120. Additionally, the above description may be equally applied to the description of directions.

Further, the first housing side portion 1121 may include a housing hole 1121a. A first coil described below may be located in the housing hole 1121a.

Additionally, the second housing side portion 1122 may include a second housing hole 1122a. Further, a second coil 1152b described below may be located in the second housing hole 1122a.

Additionally, the first housing side portion 1121 and the second housing side portion 1122 may be side surfaces of the housing 1120.

The first coil and the second coil may be coupled to the board unit. In an example, the first coil and the second coil may be electrically connected to the board unit so that current may flow. This current may be a component of an electromagnetic force that allows the first camera actuator to tilt with respect to the X-axis.

Additionally, the third housing side portion 1123 may include a third housing hole 1123a.

A third coil described below may be located in the third housing hole 1123a. Additionally, the third coil 1152c may be electrically connected to the board unit coming into contact with the housing 1120 and may be coupled to each other. Accordingly, the third coil may be electrically connected to the board unit and may receive a current supplied from the board unit. This current may be a component of an electromagnetic force that allows the first camera actuator to tilt with respect to the Y-axis.

The sixth housing side portion 1126 may be seated between the first housing side portion 1121 and the fourth housing side portion 1124. Accordingly, the sixth housing side portion 1126 may be located on the third housing side portion 1123. For example, the sixth housing side portion 1126 may be located on one side. The sixth housing side portion 1126 and the holder may be sequentially located based on the third direction.

The fourth housing side portion 1124 may be disposed between the first housing side portion 1121 and the second housing side portion 1122 and may be in contact with the first housing side portion 1121, the second housing side portion 1122, and the third housing side portion 1123.

Additionally, the fourth housing side portion 1124 may include a fourth housing hole 1124a. The fourth housing hole 1124a may be located above the optical member. Accordingly, light may pass through the fourth housing hole 1124a and may be incident on the optical member.

Furthermore, the housing 1120 may include the accommodating portion 1125 formed by the first housing side portion 1121 to the fourth housing side portion 1124. The sixth housing side portion 1126, the coupling member 1131a, and the mover 1130, which are components, may be located in the accommodating portion 1125.

In addition, the housing 1120 may further include a fifth housing side portion facing the sixth housing side portion 1126. Further, the fifth housing side portion may be disposed between the first housing side portion 1121 and the second housing side portion 1122 and may be in contact with the first housing side portion 1121, the second housing side portion 1122, and the third housing side portion 1123. In addition, the fifth housing side portion may include an opening region to provide a path along which light reflected from the optical member 1132 moves. Furthermore, the fifth housing side portion may include a protrusion, a groove, or the like to provide easy coupling to another adjacent camera actuator. With this configuration, the movement of an opening for providing an optical path due to separation or the like can be suppressed by improving the coupling force between the fifth housing side portion, which provides the optical path and in which the opening is formed, and other components, thereby minimizing a change in the optical path.

Additionally, as described above, the sixth housing side portion 1126 may be coupled to the housing 1120 and may be a configuration that is included in the housing 1120. That is, the housing 1120 may include the sixth housing side portion 1126.

Further, the sixth housing side portion 1126 may be disposed on the housing 1120. Alternatively, the sixth housing side portion 1126 may be located in the housing 1120.

Further, the sixth housing side portion 1126 may be coupled to the housing 1120. In an embodiment, the sixth housing side portion 1126 may be located between the first housing side portion 1121 and the second housing side portion 1122. Furthermore, the sixth housing side portion 1126 may be located between the third housing side portion 1123 and the fourth housing side portion 1124.

Further, the sixth housing side portion 1126 may be located on the third housing side portion 1123 and may be in contact with the first housing side portion to the third housing side portion.

Additionally, the sixth housing side portion 1126 may include a second protrusion groove PH2 in which a second protruding portion of the tilting guide unit is seated. The second protrusion groove PH2 may be located in an inner surface 1126S1 of the sixth housing side portion 1126. Accordingly, the sixth housing side portion 1126 may be disposed so that a protruding portion (for example, the second protruding portion) of the tilting guide unit is disposed adjacent to the optical member in the fourth seating groove, and thus the protruding portion thereof, which is a reference axis of tilt, may be disposed close to the center of gravity of the mover 1130. Thus, the moment that moves the mover 1130 for tilting when the holder tilts may be minimized. Accordingly, since the current consumption for driving the coil is also minimized, the power consumption of the camera actuator may be reduced.

Additionally, the sixth housing side portion 1126 may include through holes 1126a and 1126b. A plurality of through holes may be provided and may include a first through hole 1126a and a second through hole 1126b.

First and second extension portions of the coupling member described below may pass through the first through hole 1126a and the second through hole 1126b, respectively. Through this, the coupling member and the sixth housing side portion may be coupled. In other words, the housing and the mover may be coupled to each other.

The second protrusion groove PH2 may be located between the first through hole 1126a and the second through hole 1126b. With this configuration, the coupling force between the tilting guide unit 1141 and the sixth housing side portion 1126 may be improved so that the deterioration of tilt accuracy caused by the tilting guide unit 1141 moving in the housing can be inhibited.

Additionally, the housing side portion of the housing 1120 may include the second groove gr2. For example, the sixth housing side portion 1126 may include the second groove gr2. The second groove gr2 may be positioned to face the first groove gr1. The second groove gr2 may be located in an outer surface 1126S2 of the sixth housing side portion 1126. The elastic member may be seated in the second groove gr2. Further, the outer surface 1126S2 of the sixth housing side portion 1126 may face an inner surface of the coupling member or a member base portion. Furthermore, the elastic member may be seated in a first groove of the coupling member and a second groove of the sixth housing side portion 1126. The first and second grooves face each other, and the elastic member between the first groove and the second groove may generate the above-described elastic restoring force. Accordingly, since the sixth housing side portion 1126 may press the tilting guide unit inward or the holder by the elastic restoring force, the mover may be spaced a predetermined distance apart from the third housing side portion in the housing even when there is no current application into the coil. In other words, the coupling force between the mover and the housing, and the tilting guide unit may be maintained. Additionally, in this embodiment, the coupling force between the mover and the housing, and the tilting guide unit may be maintained by the elastic restoring force.

In addition, when the sixth housing side portion 1126 is formed integrally with the housing 1120, the coupling force between the sixth housing side portion 1126 and the housing 1120 is improved, thereby improving the reliability of the camera actuator. In addition, when the sixth housing side portion 1126 is formed separately from the housing 1120, the ease of assembly and production of the sixth housing side portion 1126 and the housing 1120 may be improved.

Further, in an embodiment, the sixth housing side portion 1126 may include the first through hole 1126a and the second through hole 1126b, as described above. Further, the first through hole 1126a and the second through hole 1126b may be disposed side by side in the second direction (Y-axis direction) and may overlap each other.

Further, the sixth housing side portion 1126 may include an upper member UA located above the first through hole 1126a and the second through hole 1126b, and a lower member BA located below the first through hole 1126a and the second through hole 1126b. Accordingly, the first through hole 1126a and the second through hole 1126b may be located in the middle of the sixth housing side portion 1126. That is, the sixth housing side portion 1126 may include a connecting member MA located at a side portion of each of the first through hole 1126a and the second through hole 1126b. That is, the upper member UA and the lower member BA may be connected to each other via the connecting member MA. Further, a plurality of lower members BA may be provided to form the first and second through holes and may be disposed spaced apart from each other in the second direction (Y-axis direction).

Thus, the sixth housing side portion 1126 may have the upper member UA to improve rigidity. For example, the rigidity of the sixth housing side portion 1126 may increase compared to when the upper member UA is absent. For example, in this embodiment, the rigidity may be in units of N/μm. Accordingly, the reliability of the first camera actuator according to the embodiment may be improved.

Further, the second groove gr2 may be located below a first line CL1 bisecting the housing 1120 or the sixth housing side portion 1126 in the first direction (X-axis direction). Furthermore, the second groove gr2 may be located between the first through hole 1126A and the second through hole 1126B. The second groove gr2 may overlap the first through hole 1126a and the second through hole 1126b in the second direction (Y-axis direction). Furthermore, the first and second grooves may have various structures, such as grooves, recesses, holes, or the like.

Furthermore, in the case of a structure where the sixth housing side portion 1126 is separated from the housing 1120, the sixth housing side portion 1126 may further include a first protruding portion and a second protruding portion. The first protruding portion may be in contact with the first housing side portion, and the second protruding portion may be in contact with the second housing side portion. The first protruding portion may extend in the third direction (Z-axis direction) from one end portion of the outer surface 1126S2 of the sixth housing side portion. The second protruding portion may extend in the third direction (Z-axis direction) from the other end portion of the outer surface 1126S2 of the sixth housing side portion. That is, the first protruding portion and the second protruding portion may extend toward the holder.

Furthermore, the housing 1120 may include a housing groove HG disposed in a surface thereof facing the second protruding portion. That is, the housing groove HG may be located in an inner surface facing the second protruding portion of the tilting guide unit. At least a part of the second protruding portion may be seated in the second protrusion groove PH2. Further, the tilting guide unit and the mover may be tilted by the second protruding portion in the second protrusion groove PH2. Furthermore, the housing groove HG may inhibit the second protruding portion from being detached from the second protrusion groove PH2. Furthermore, overflow of the coupling member may be suppressed. Thus, the reliability of the first camera actuator may be improved because the detachment and damage due to the impact of a first protruding portion PR1 or a second protruding portion PR2 are suppressed.

FIG. 7 is a perspective view of an optical member of the first camera actuator according to the embodiment.

The optical member 1132 may be seated in the holder. The optical member 1132 may be a right-angled prism or reflective member as a reflecting unit, but is not limited thereto.

In an embodiment, the optical member 1132 may have a protruding portion (not shown) on a part of an outer surface. The optical member 1132 may be easily coupled to the holder via the protruding portion (not shown). Additionally, the holder may have a groove or a protrusion to be coupled to the optical member 1132.

Additionally, in the optical member 1132, a bottom surface 1132b may be seated on a seating surface of the holder. Accordingly, in the optical member 1132, the bottom surface 1132b may correspond to the seating surface of the holder. In an embodiment, the bottom surface 1132b may be formed as an inclined surface in the same manner as the seating surface of the holder. Accordingly, the prism may move as the holder moves, and at the same time, the optical member 1132 may be inhibited from being separated from the holder in accordance with this movement.

Additionally, a groove may be formed in the bottom surface 1132b of the optical member 1132 and a bonding member may be applied to the groove so that the optical member 1132 may be coupled to the holder. Alternatively, the bonding member may be applied to the groove or protrusion of the holder so that the holder is coupled to the optical member 1132.

Additionally, as described above, the optical member 1132 may be configured to have a structure that is capable of reflecting light reflected from the outside (for example, an object) into the camera module. As in the embodiment, the optical member 1132 may include one mirror.

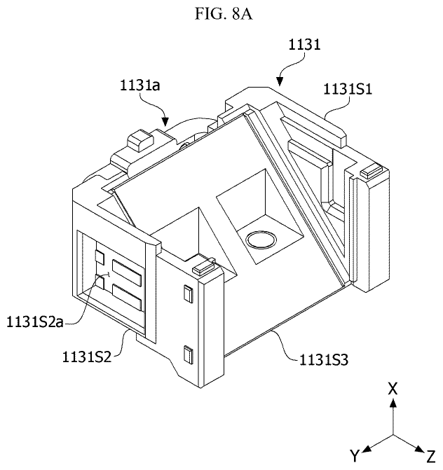

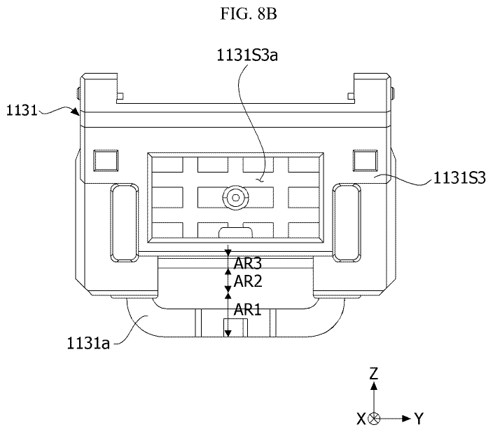

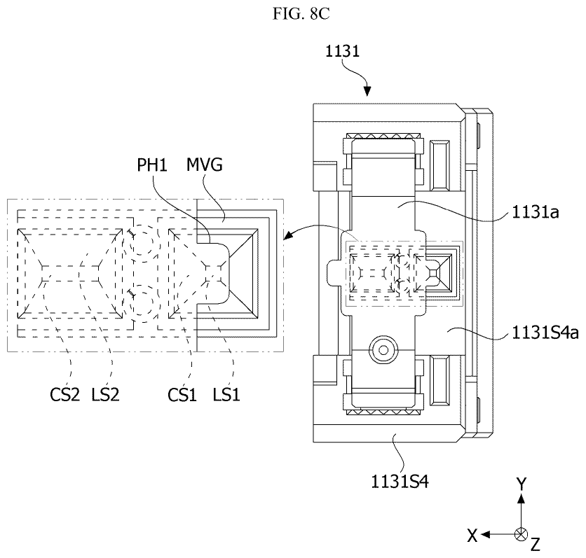

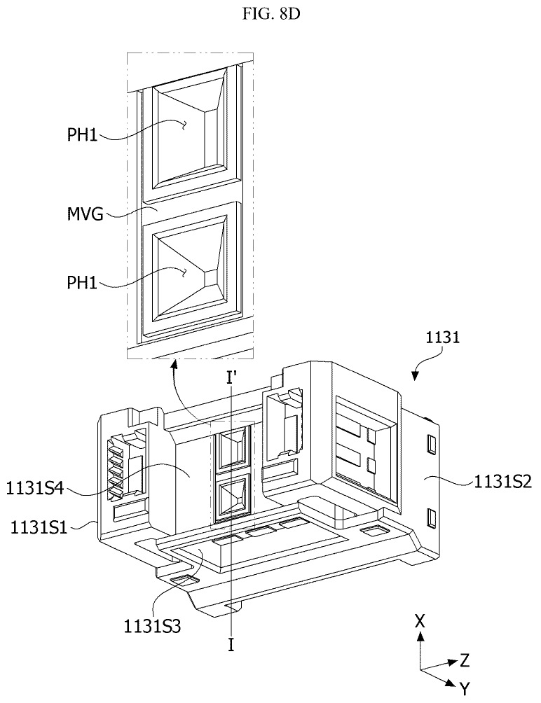

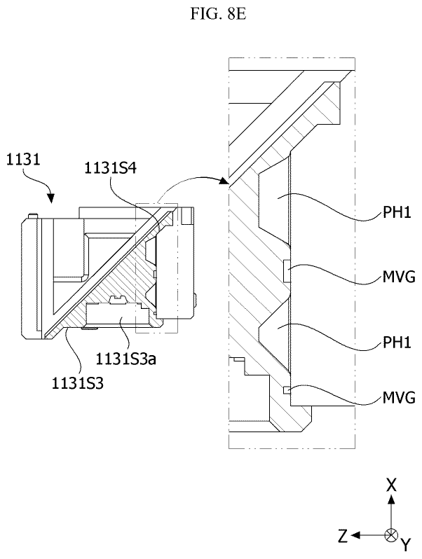

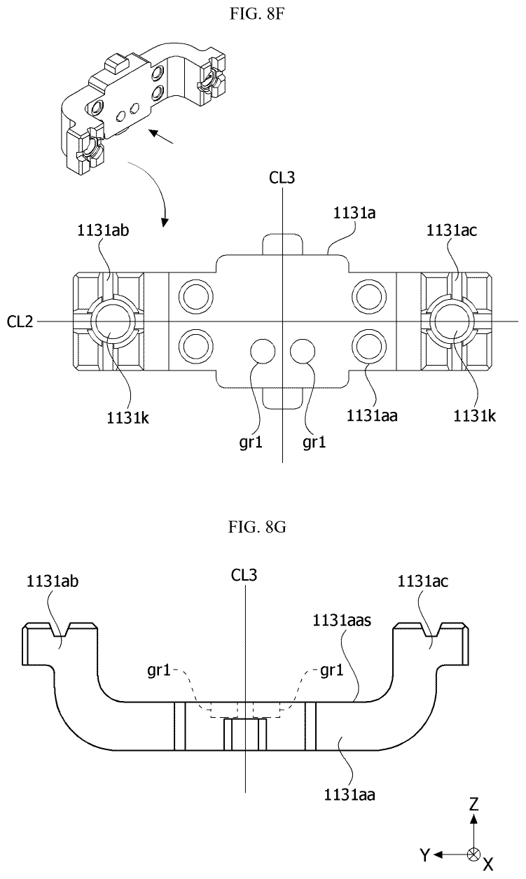

FIG. 8A is a perspective view of the holder of the first camera actuator according to the embodiment, FIG. 8B is a bottom view of the holder of the first camera actuator according to the embodiment, FIG. 8C is a front view of the holder of the first camera actuator according to the embodiment, FIG. 8D is another perspective view of the holder of the first camera actuator according to the embodiment, FIG. 8E is a cross-sectional view along line II′ in FIG. 8D, FIG. 8F is a rear view of the coupling member of the first camera actuator according to the embodiment, and FIG. 8G is a bottom view of the coupling member of the first camera actuator according to the embodiment.

Referring to FIGS. 8A to 8E, the holder 1131 may include a seating surface on which the optical member 1132 is seated. The seating surface may be an inclined surface.

The holder 1131 may include a plurality of outer surfaces. For example, the holder 1131 may include a first holder outer surface 1131S1, a second holder outer surface 1131S2, a third holder outer surface 1131S3, and a fourth holder outer surface 1131S4.

The first holder outer surface 1131S1 may be positioned opposite to the second holder outer surface 1131S2. The first holder outer surface 1131S1 and the second holder outer surface 1131S2 may be symmetrically disposed in the first direction (X-axis direction).

The first holder outer surface 1131S1 may be positioned to correspond to the first housing side portion. That is, the first holder outer surface 1131S1 may be positioned to face the first housing side portion. Further, the second holder outer surface 1131S2 may be positioned to correspond to the second housing side portion. That is, the second holder outer surface 1131S2 may be positioned to face the second housing side portion.

Furthermore, the first holder outer surface 1131S1 may include a first seating groove 1131S1a. Further, the second holder outer surface 1131S2 may include a second seating groove 1131S2a. The first seating groove 1131S1a and the second seating groove 1131S2a may be symmetrically disposed in the first direction (X-axis direction).

Furthermore, the first seating groove 1131S1a and the second seating groove 1131S2a may be disposed to overlap in the second direction (Y-axis direction). Further, a first magnet 1151a may be disposed in the first seating groove 1131S1a, and a second magnet 1151b may be disposed in the second seating groove 1131S2a. The first magnet 1151a and the second magnet 1151b may also be symmetrically disposed in the first direction (X-axis direction). In this specification, it should be understood that the first to third magnets can be coupled to the housing through the yoke or the bonding member.

As described above, depending on the positions of the first and second seating grooves and the first and second magnets, the electromagnetic force induced by each of the magnets may be provided on the same axis to the first holder outer surface S1131S1 and the second holder outer surface 1131S2. For example, a region in which the electromagnetic force is applied to the first holder outer surface S1131S1 (for example, a region where the electromagnetic force is strongest) and a region in which the electromagnetic force is applied to the second holder outer surface S1131S2 (for example, a region where the electromagnetic force is strongest) may be located on an axis parallel to the second direction (Y-axis direction). Thus, X-axis tilting may be performed accurately.

The first magnet 1151a may be disposed in the first seating groove 1131S1a, and the second magnet 1151b may be disposed in the second seating groove 1131S2a.

The third holder outer surface 1131S3 may be an outer surface that is in contact with the first holder outer surface 1131S1 and the second holder outer surface 1131S2 and extends in the second direction (Y-axis direction) from one side of each of the first holder outer surface 1131S1 and the second holder outer surface 1131S2. Furthermore, the third holder outer surface 1131S3 may be located between the first holder outer surface 1131S1 and the second holder outer surface 1131S2. The third holder outer surface 1131S3 may be a bottom surface in the holder 1131. That is, the third holder outer surface 1131S3 may be positioned to face the third housing side portion.

Furthermore, the third holder outer surface 1131S3 may include a third seating groove 1131S3a. A third magnet 1151c may be disposed in the third seating groove 1131S3a. The third holder outer surface 1131S3 may be positioned to face the third housing side portion 1123.

Furthermore, the third housing hole 1123a may at least partially overlap the third seating groove 1131S3a in the first direction (X-axis direction). Accordingly, the third magnet 1151c in the third seating groove 1131S3a and the third coil 1152c in the third housing hole 1123a may be positioned to face each other. Further, the third magnet 1151c and the third coil 1152c may generate an electromagnetic force so that the first camera actuator may tilt with respect to the Y-axis.

Additionally, the X-axis tilt may be achieved by a plurality of magnets (the first and second magnets 1151a and 1151b), whereas the Y-axis tilt may be achieved only by the third magnet 1151c.

In an example, the third seating groove 1131S3a may have an area that is greater than that of the first seating groove 1131S1a or the second seating groove 1131S2a. With this configuration, the Y-axis tilt may be performed with current control similar to that of the X-axis tilt.

The fourth holder outer surface 1131S4 may be an outer surface that is in contact with each of the first holder outer surface 1131S1 and the second holder outer surface 1131S2 and extends in the first direction (X-axis direction) from the first holder outer surface 1131S1 and the second holder outer surface 1131S2. Furthermore, the fourth holder outer surface 1131S4 may be located between the first holder outer surface 1131S1 and the second holder outer surface 1131S2. That is, the fourth holder outer surface 1131S4 may be positioned to face the sixth housing side portion.

The fourth holder outer surface 1131S4 may include a fourth seating groove 1131S4a. The tilting guide unit 1141 may be located in the fourth seating groove 1131S4a. Additionally, the coupling member 1131a and the sixth housing side portion 1126 may be located in the fourth seating groove 1131S4a. Further, the fourth seating groove 1131S4a may include a plurality of regions. The fourth seating groove 1131S4a may include a first region AR1, a second region AR2, and a third region AR3.

The coupling member 1131a may be located in the first region AR1. That is, the first region AR1 may overlap the coupling member 1131a in the first direction (X-axis direction). Particularly, the first region AR1 may be a region where the member base portion of the coupling member 1131a is located. In this case, the first region AR1 may be located on the fourth holder outer surface 1131S4. That is, the first region AR1 may correspond to a region located above the fourth seating groove 1131S4a. In this case, the first region AR1 may not be a region in the fourth seating groove 1131S4a.

The sixth housing side portion 1126 may be located in the second region AR2. That is, the second region AR2 may overlap the sixth housing side portion 1126 in the first direction (X-axis direction).

Furthermore, the second region AR2 may be located on the fourth holder outer surface 1131S4, like the first region. That is, the second region AR2 may correspond to a region located above the fourth seating groove 1131S4a.

The tilting guide unit may be located in the third region AR3. Particularly, the base of the tilting guide unit may be located in the third region AR3. That is, the third region AR3 may overlap the tilting guide unit (for example, the base) in the first direction (X-axis direction).

Furthermore, the second region AR2 may be located between the first region AR1 and the third region AR3.

Further, the coupling member is disposed in the first region AR1, and the coupling member 1131a may include the first groove gr1. In an embodiment, the coupling member 1131A may include the first groove gr1 formed in an inner surface 1131aas. Further, the elastic member may be disposed in the first groove gr1 as described above.

Further, as described above, the sixth housing side portion may be disposed in the second region AR2. The first groove gr1 may be positioned to face the second groove gr2. For example, the first groove gr1 may at least partially overlap the second groove gr2 in the third direction (Z-axis direction).

Further, the elastic restoring force of the elastic member may be transmitted to the fourth seating groove 1131S4a of the holder 1131 through the coupling member. Thus, the holder may apply a force to the tilting guide unit in a direction the same as that of the elastic restoring force generated by the elastic member.

The sixth housing side portion may include a second groove facing the first groove formed in the outer surface. Furthermore, the sixth housing side portion may include a second protrusion groove formed in the inner surface as described above. Further, the second protruding portion may be seated in the second protrusion groove.

The tilting guide unit 1141 may be disposed in the third region AR3.

Further, a first protrusion groove PH1 may be located in the fourth seating groove 1131S4a. Additionally, the first protruding portion of the tilting guide unit 1141 may be accommodated in the first protrusion groove PH1. Accordingly, the first protruding portion PR1 may come into contact with the first protrusion groove. The first protrusion groove PH1 may have a maximum diameter corresponding to a maximum diameter of the first protruding portion PR1. The same can apply to the second protrusion groove and the second protruding portion PR2. That is, the second protrusion groove may have a maximum diameter corresponding to a maximum diameter of the second protruding portion PR2. Accordingly, the second protruding portion may come into contact with the second protrusion groove. With this configuration, a first-axis tilt based on the first protruding portion and a second-axis tilt based on the second protruding portion may easily occur, and the radii of the tilts can be improved.

Furthermore, in an embodiment, a plurality of first protrusion grooves PH1 may be provided. For example, one of the first protrusion groove PH1 and the second protrusion groove PH2 may include a 1-1 protrusion groove PH1a and a 1-2 protrusion groove PH1b. In the following description, the first protrusion groove PH1 is described as including the 1-1 protrusion groove PH1a and the 1-2 protrusion groove PH1b. Further, the following description may also be equally applied to the second protrusion groove PH2. For example, the second protrusion groove PH2 may include a 2-1 protrusion groove and a 2-2 protrusion groove, the description of the 1-1 protrusion groove may be applied to the 2-1 protrusion groove, and the description of the 1-2 protrusion groove may be applied to the 2-2 protrusion groove.

The 1-1 protrusion groove PH1a and the 1-2 protrusion groove PH1b may be disposed side by side in the first direction (X-axis direction). Maximum areas of the 1-1 protrusion groove PH1a and the 1-2 protrusion groove PH1b may be the same.

At least one first protrusion groove PH1 may be provided. At least one second protrusion groove PH2 may also be provided. In an embodiment, a plurality of first protrusion grooves PH1 or second protrusion grooves PH2 may have different numbers of inclined surfaces. For example, the plurality of first protrusion grooves PH1 may have different numbers of inclined surfaces. For example, the first protrusion groove PH1 may include a groove bottom surface and an inclined surface. In this case, a plurality of protrusion grooves may have different numbers of inclined surfaces. Furthermore, areas of bottom surfaces in the protrusion grooves may also vary.

For example, the 1-1 protrusion groove PH1a may include a first groove bottom surface LS1 and a first inclined surface CS1. The 1-2 protrusion groove PHIb may include a second groove bottom surface LS2 and a second inclined surface CS2.

At this time, the first groove bottom surface LS1 and the second groove bottom surface LS2 may have different areas. An area of the first groove bottom surface LS1 may be smaller than an area of the second groove bottom surface LS2.

Additionally, the number of first inclined surfaces CS1 in contact with the first groove bottom surface LS1 may be different from the number of second inclined surfaces CS2. For example, the number of first inclined surfaces CS1 may be greater than the number of second inclined surfaces CS2.

With this configuration, the assembly tolerance of the first protruding portion that is seated in the first protrusion groove PH1 can be easily compensated for. For example, since the number of first inclined surfaces CS1 is greater than the number of second inclined surfaces CS2, the first protruding portion comes into contact with more inclined surfaces, and thus the position of the first protruding portion in the 1-1 protrusion groove PH1a may be more accurately maintained.

In contrast, since the number of inclined surfaces in contact with the first protruding portion in the 1-2 protrusion groove PH1b is smaller than that of the 1-1 protrusion groove PHIb, the position of the first protruding portion may be easily adjusted. Furthermore, the numbers of inclined surfaces may be the same.

Additionally, sizes of the inclined surfaces may be different. Also, in some cases, the sizes of the inclined surfaces may be different.

In an embodiment, the second inclined surfaces CS2 may be disposed spaced apart from each other in the second direction (Y-axis direction). Further, the second groove bottom surface LS2 extends in the first direction (X-axis direction) so that the first protruding portion may easily move in the first direction (X-axis direction) while in contact with the second inclined surfaces CS2. That is, the first protruding portion may be easily located in the 1-2 protrusion groove PH1b.

Further, in this embodiment, the first region AR1, the second region AR2, and the third region AR3 may have different heights in the first direction (X-axis direction). In an embodiment, the first region AR1 may have a greater height in the first direction (X-axis direction) than the second region AR2 and the third region AR3. Accordingly, a step may be located between the first region AR1 and the second region AR2.

In an embodiment, the mover may include the optical member and the holder 1131 in which the optical member is seated, as described above.

The mover 1130 may include a mover groove MVG disposed in an outer surface facing the tilting guide unit and the first protrusion groove PH1.

For example, the mover 1130 may include the mover groove MVG and the first protrusion groove PH1. The mover 1130 may have a structure in which a jaw is formed as the first protrusion groove PH1 is formed in the mover groove MVG.

The mover groove MVG may be located in the fourth holder outer surface 1131S4, which is an outer surface facing the tilting guide unit. The mover groove MVG may be disposed to surround the first protrusion groove PH1 in the fourth holder outer surface 1131S4.

Furthermore, a width of the first protrusion groove PH1 in the mover groove MVG may vary depending on the position thereof. For example, the 1-1 protrusion groove PH1a may be located below the 1-2 protrusion groove PH1b. That is, the 1-2 protrusion groove PH1b may be located on the first direction (X-axis direction) side with respect to the 1-1 protrusion groove PH1a.

Furthermore, the mover groove MVG may suppress the overflow of a coupling member applied to the first protrusion groove PH1. Furthermore, it is possible to improve the capturing of foreign matter. Thus, the reliability of the first camera actuator may be improved.

Referring to FIGS. 8F and 8G, the coupling member 1131a may include a member base portion 1131aa, a first extension portion 1131ab, and a second extension portion 1131ac.

Additionally, the coupling member 1131a may include the first groove gr1. In other words, the first groove gr1 may be located in an inner surface of the member base portion 1131aa. Further, the above-described elastic member may be seated in the first groove gr1. Furthermore, a plurality of first grooves gr1 may be provided depending on the number of elastic members. That is, the first groove gr1 may be provided in a number corresponding to the number of elastic members.

The member base portion 1131aa may be located on the outermost side of the first camera actuator. The member base portion 1131aa may be located outside the sixth housing side portion. That is, the sixth housing side portion may be located between the member base portion 1131aa and the tilting guide unit.

The first extension portion 1131ab may extend in the third direction (Z-axis direction) from an edge or one end of the member base portion 1131aa. That is, the first extension portion 1131ab may extend from the member base portion 1131aa toward the holder 1131. The same also applies to the second extension portion 1131ac. Furthermore, the second extension portion 1131ac may extend in the third direction (z-axis direction) from an edge or the other end of the member base portion 1131aa. In an embodiment, the first extension portion 1131ab and the second extension portion 1131ac may be located at an edge of the member base portion 1131aa in the second direction (Y-axis direction). Further, the first extension portion 1131ab and the second extension portion 1131ac may be disposed between the upper member and the lower member.

Accordingly, the coupling member 1131a may have a groove formed by the first extension portion 1131ab and the second extension portion 1131ac. That is, the groove may be located between the first extension portion 1131ab and the second extension portion 1131ac. Accordingly, the first extension portion 1131ab and the second extension portion 1131ac may be connected to each other only by the member base portion 1131aa. With this configuration, the coupling member 1131a can continuously receive the elastic restoring force by the elastic member seated in a center of the member base portion 1131aa, particularly, in the first groove gr1.

Further, since the coupling member 1131a may be coupled to the holder and may move during the X-axis tilt and the Y-axis tilt, the rigidity of the coupling member 1131a may be greater than the rigidity of the sixth housing side portion.

Furthermore, as described above, the sixth housing side portion according to the embodiment may have an upper member and a lower member to increase rigidity. With this configuration, a difference in rigidity between the coupling member and the sixth housing side portion can be reduced. Thus, when the coupling member 1131a and the holder 1131 coupled to the coupling member 1131a are both tilted with respect to the X-axis or tilted with respect to the Y-axis, the coupling member 1131a may have a smaller proximity distance to the sixth housing side portion and come into contact with the sixth housing side portion. Thus, the sixth housing side portion may have improved rigidity as described above to easily perform the operation as a stopper. That is, the reliability of the camera actuator may be improved.

Furthermore, the difference in rigidity between the sixth housing side portion and the coupling member may be reduced so that damage caused by contact during tilting may be minimized. That is, the reliability of the camera actuator may be improved.

Furthermore, the first extension portion 1131ab may be spaced apart from the second extension portion 1131ac in the second direction (Y-axis direction) to form a separation space. The sixth housing side portion and the tilting guide unit may be seated in this separation space. In addition, the elastic member may be located in the separation space.

Furthermore, the first extension portion 131ab and the second extension portion 131ac may have the same length in the third direction (Z-axis direction). Thus, the coupling force, the weight, and the like are formed in a balanced manner so that the tilt of the holder may be performed accurately without being tilted to one side.

Further, the first extension portion 1131ab and the second extension portion 1131ac may be coupled to the holder. In this specification, it should be understood that the coupling can include being coupled to each other through a bonding member other than the protrusion and groove structures described above. In an embodiment, the first extension portion 131ab and the second extension portion 131ac may include third coupling grooves 1131k formed in the third direction (Z-axis direction). Furthermore, coupling protrusions 1131m may be located in a region in the fourth seating groove 1131S4a which overlaps the first extension 1131ab and the second extension 1131ac in the third direction (Z-axis direction). The coupling protrusions 1131m may be positioned to correspond to the third coupling grooves 1131k.

For example, a bonding member such as epoxy may be applied to the third coupling grooves 1131k. Further, the coupling protrusions 1131m may be inserted into the third coupling grooves 1131k of the first extension portion 1131ab and the second extension portion 1131ac. With this configuration, the coupling member 1131a and the holder 1131 may be coupled to each other. Additionally, the elastic restoring force applied to the coupling member 1131a may be transmitted to the holder 1131 through this coupling. However, as described above, it should be understood that the positions of the protrusion and groove structures can be interchanged with each other.

Furthermore, the first groove gr1 may be located below a second line CL2. The second line CL2 may be a line bisecting the coupling member 1131a in the first direction (X-axis direction). With this configuration, an elastic restoring force may be applied more efficiently to the mover.

Further, a plurality of first grooves gr1 may be symmetrically located based on a third line CL3. For example, the plurality of first grooves gr1 may overlap in the second direction (Y-axis direction). The third line CL3 may be a line bisecting the coupling member 1131a in the second direction (Y-axis direction).

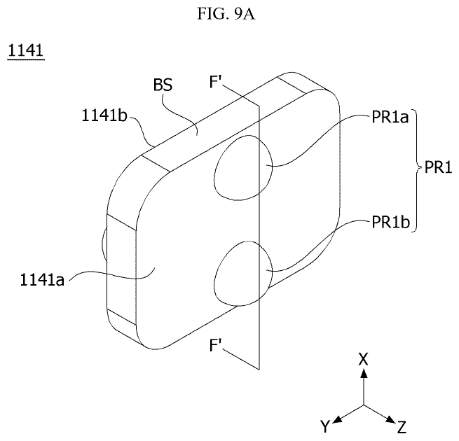

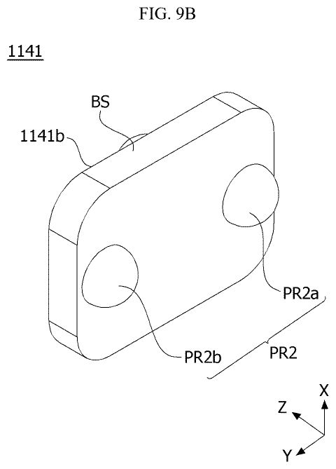

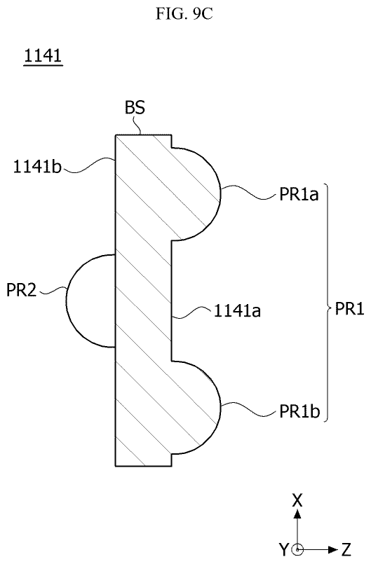

FIG. 9A is a perspective view of the tilting guide unit of the first camera actuator according to the embodiment, FIG. 9B is a perspective view in a direction different from that of FIG. 9A, and FIG. 9C is a cross-sectional view along line FF′ in FIG. 9A.

Referring to FIGS. 9A to 9C, the tilting guide unit 1141 according to the embodiment may include a base BS, the first protrusion PR1 protruding from a first surface 1141a of the base BS, and the second protrusion PR2 protruding from a second surface 1141b of the base BS. In addition, although the first protruding portion and the second protruding portion may be formed on opposite surfaces depending on the structure thereof, the following description will be made based on the drawings. Also, it should be understood that the first protruding portion PR1 and the second protruding portion PR2 can be formed integrally with the base BS, and that the first protruding portion PR1 and the second protruding portion RP2 can have a spherical shape, like a ball, as shown in the drawings. That is, the tilting guide unit 1141 may have a configuration that includes a ball member, a rolling member, a ball, a separated hemisphere, or the like. In the case of an integrated type, the inflow or the like of foreign matter into the tilting guide unit 1141 may be suppressed so that reliability may be improved.

First, the base BS may include the first surface 1141a and the second surface 1141b opposite to the first surface 1141a. That is, the first surface 1141a and the second surface 1141b may be spaced apart from each other in the third direction (Z-axis direction) and may be outer surfaces opposing or facing each other in the tilting guide unit 1141.

The tilting guide unit 1141 may include the first protruding portion PR1 extending to one side on the first surface 1141a. According to the embodiment, the first protruding portion PR1 may protrude from the first surface 1141a toward the holder. A plurality of first protruding portions PR1 may be provided and may include a 1-1 protruding portion PR1a and a 1-2 protruding portion PR1b.

The 1-1 protruding portion PR1a and the 1-2 protruding portion PR1b may be positioned side by side in the first direction (X-axis direction). In other words, the 1-1 protruding portion PR1a and the 1-2 protruding portion PR1b may overlap in the first direction (X-axis direction). Furthermore, in an embodiment, the 1-1 protruding portion PR1a and the 1-2 protruding portion PR1b may be bisected by an imaginary line extending in the first direction (X-axis direction).

Furthermore, each of the 1-1 protruding portion PR1a and the 1-2 protruding portion PR1b may have a curvature, and have, for example, a hemispherical shape. Further, the first protruding portion PR1a and the second protruding portion PR1b may come into contact with the first groove of the housing at a point that is furthest from the first surface 1141a of the base BS.

Additionally, an alignment groove 1141aa may be located in the first surface 1141a. The alignment groove 1141aa may be disposed on one side in the first surface 1141a and may provide an assembly position or assembly direction of the tilting guide unit 1141 during the assembly process.

Additionally, the tilting guide unit 1141 may include the second protrusion PR2 extending to one side on the second surface 1141b. According to the embodiment, the second protruding portion PR2 may protrude from the second surface 1141b toward the housing. Further, a plurality of second protruding portions PR2 may be provided, and in an embodiment, may include a 2-1 protruding portion PR2a and a second protruding portion PR2b.

The 2-1 protruding portion PR2a and the 2-2 protruding portion PR2b may be positioned side by side in the second direction (Y-axis direction). That is, the 2-1 protruding portion PR2a and the 2-2 protruding portion PR2b may overlap in the second direction (Y-axis direction). Furthermore, in an embodiment, the 2-1 protruding portion PR2a and the 2-2 protruding portion PR2b may be bisected by an imaginary line extending in the second direction (Y-axis direction).

Each of the 2-1 protruding portion PR2a and the 2-2 protruding portion PR2b may have a curvature and have, for example, a hemispherical shape. Further, the 2-1 protruding portion PR2a and the 2-2 protruding portion PR2b may come into contact with the coupling member 1131a at points that are spaced apart from the second surface 1141b of the base BS.

The 1-1 protruding portion PR1a and the 1-2 protruding portion PR1b may be located in a region between the 2-1 protruding portion PR2a and the 2-2 protruding portion PR2b in the second direction. According to the embodiment, the 1-1 protruding portion PR1a and the 1-2 protruding portion PR1b may be located at a center of a separation space between the 2-1 protruding portion PR2a and the 2-2 protruding portion PR2b in the second direction. With this configuration, the actuator according to the embodiment may have an angle of the X-axis tilt within the same range with respect to the X-axis. In other words, the tilting guide unit 1141 may provide the holder with the same range (for example, positive/negative range) in which the holder can tilt with respect to the X-axis based on the 1-1 protruding portion PR1a and the 1-2 protruding portion PR1b with respect to the X-axis.

Additionally, the 2-1 protruding portion PR2a and the 2-2 protruding portion PR2b may be located in a region between the 1-1 protruding portion PR1a and the 1-2 protruding portion PR1b in the first direction. According to the embodiment, the 2-1 protruding portion PR2a and the 2-2 protruding portion PR2b may be located at a center of a separation space between the 1-1 protruding portion PR1a and the 1-2 protruding portion PR1b in the first direction. With this configuration, the actuator according to the embodiment may have an angle of the Y-axis tilt within the same range with respect to the Y-axis. In other words, based on the 2-1 protruding portion PR2a and the 2-2 protruding portion PR2b, the tilting guide unit 1141 and the holder may provide the same range (for example, positive/negative range) of Y-axis tilt based on the Y-axis.

The first protruding portion PR1 may protrude from the base BS toward the mover 1130, and the second protruding portion PR2 may protrude from the base BS toward the sixth housing side portion or in a direction opposite to that of the first protruding portion PR1.

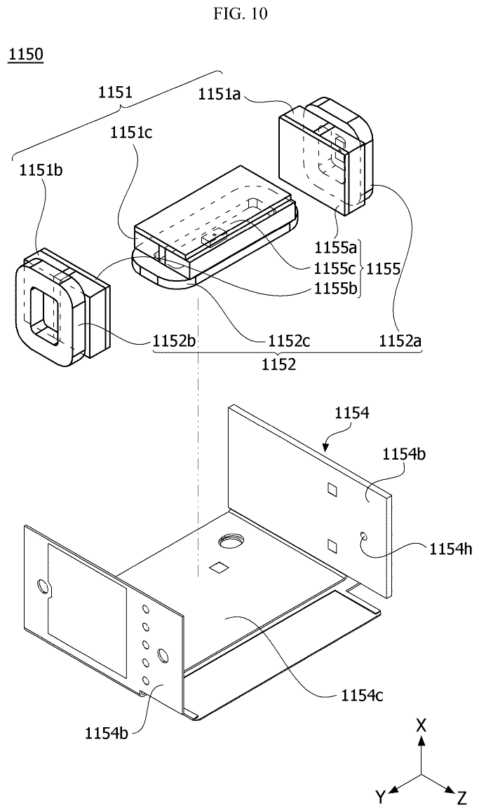

FIG. 10 is a view showing the driving unit of the first camera actuator according to the embodiment.

Referring to FIG. 10, the driving unit 1150 includes the driving magnet 1151, the driving coil 1152, the Hall sensor unit 1153, the board unit 1154, and the yoke unit 1155.

Furthermore, as described above, the driving magnet 1151 may include a first magnet 1151a, a second magnet 1151b, and a third magnet 1151c that provide a driving force by an electromagnetic force. The first magnet 1151a, the second magnet 1151b, and the third magnet 1151c may each be located on an outer surface of the holder 1131.

Additionally, the driving coil 1152 may include a plurality of coils. In an embodiment, the driving coil 1152 may include a first coil 1152a, a second coil 1152b, and a third coil 1152c.

The first coil 1152a may be positioned opposite to the first magnet 1151a. Accordingly, the first coil 1152a may be located in the housing hole 1121a of the first housing side portion 1121, as described above. Furthermore, the second coil 1152b may be positioned opposite to the second magnet 1151b. Accordingly, the second coil 1152b may be located in the second housing hole 1122a of the second housing side portion 1122, as described above.

The first camera actuator according to the embodiment may control the rotation of the mover 1130 in a first-axis (X-axis direction) or a second-axis (Y-axis direction) using an electromagnetic force between the driving magnet 1151 and the driving coil 1152, thereby minimizing the occurrence of decentering or tilt phenomena when implementing OIS to provide the best optical characteristics.

Furthermore, according to the embodiment, as OIS is implemented through the tilting guide unit 1141 of the rotating unit 1140 disposed between the housing 1120 and the mover 1130, the size limitations of the actuator may be resolved, thereby providing an ultra-slim, ultra-small camera actuator and a camera module including the same.

The board unit 1154 may include a first board side portion 1154a, a second board side portion 1154b, and a third board side portion 1154c.

The first board side portion 1154a and the second board side portion 1154b may be disposed to face each other. Further, the third board side portion 1154c may be located between the first board side portion 1154a and the second board side portion 1154b.

Furthermore, the first board side portion 1154a may be located between the first housing side portion and the shield can, and the second board side portion 1154b may be located between the second housing side portion and the shield can. Additionally, the third board side portion 1154c may be located between the third housing side portion and the shield can, and may be a bottom surface of the board unit 1154.

The first board side portion 1154a may be coupled and electrically connected to the first coil 1152a. Additionally, the first board side portion 1154a may be coupled and electrically connected to a first Hall sensor 1153a.

The second board side portion 1154b may be coupled and electrically connected to the second coil 1152b. Additionally, it should be understood that the second board side portion 1154b may be coupled and electrically connected to the first Hall sensor.

The third board side portion 1154c may be coupled and electrically connected to the third coil 1152c. Additionally, the third board side portion 1154c may be coupled and electrically connected to a second Hall sensor 1153b.

The yoke unit 1155 may include a first yoke 1155a, a second yoke 1155b, and a third yoke 1155c. The first yoke 1155a may be located in the first seating groove and may be coupled to the first magnet 1151a. Additionally, the second yoke 1155b may be located in the second seating groove and may be coupled to the second magnet 1151b. Additionally, the third yoke 1155c may be located in the third seating groove and may be coupled to the third magnet 1151c. The first yoke 1155a to the third yoke 1155c allow the first magnet 1151a to the third magnet 1151c to be easily seated in the first to third seating grooves and coupled to the housing.

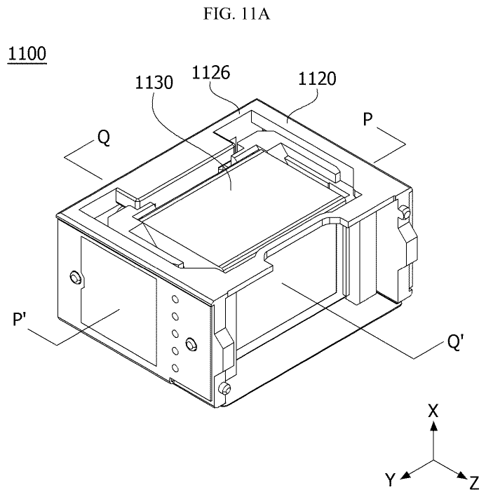

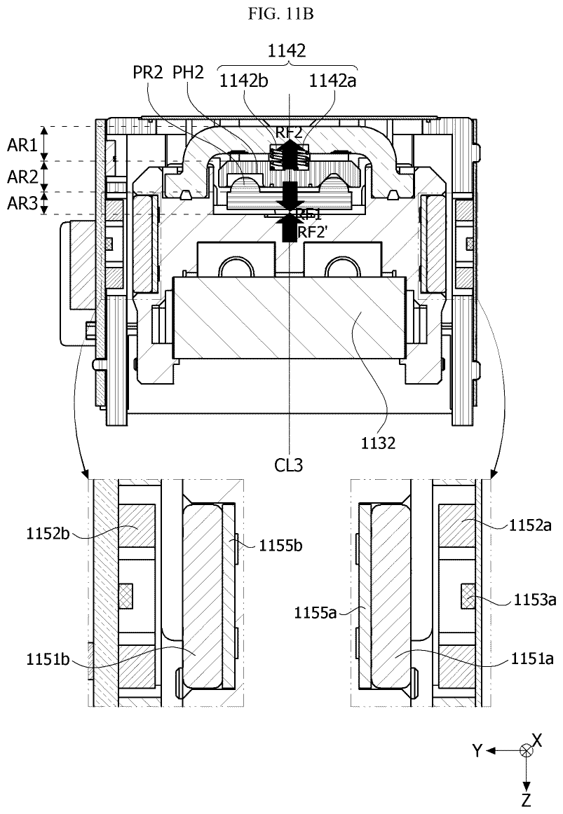

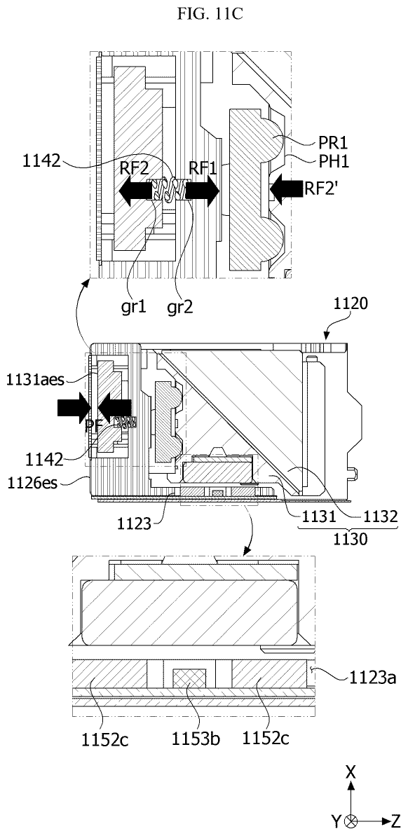

FIG. 11A is a perspective view of the first camera actuator according to the embodiment, FIG. 11B is a cross-sectional view along line PP′ in FIG. 11A, and FIG. 11C is a cross-sectional view along line QQ′ in FIG. 11A.

Referring to FIGS. 11A to 11C, the first coil 1152a may be located on the first housing side portion 1121 and the first magnet 1151a may be located on the first holder outer surface 1131S1 of the holder 1131. Accordingly, the first coil 1152a and the first magnet 1151a may be positioned opposite to each other. The first magnet 1151a may at least partially overlap the first coil 1152a in the second direction (Y-axis direction).

Additionally, the second coil 1152b may be located on the second housing side portion 1122, and the second magnet 1151b may be located on the second holder outer surface 1131S2 of the holder 1131. Accordingly, the second coil 1152b and the second magnet 1151b may be positioned opposite to each other. The second magnet 1151b may at least partially overlap the second coil 1152b in the second direction (Y-axis direction).

Furthermore, the first coil 1152a may overlap the second coil 1152b in the second direction (Y-axis direction), and the first magnet 1151a may overlap the second magnet 1151b in the second direction (Y-axis direction).

With this configuration, the electromagnetic force applied to the outer surface of the holder (the first holder outer surface and the second holder outer surface) may be located on a parallel axis in the second direction (Y-axis direction) so that the X-axis tilt can be performed accurately and precisely.

Furthermore, the second protruding portions PR2a and PR2b of the tilting guide unit 1141 may come into contact with the sixth housing side portion 1126 of the housing 1120. The second protruding portion PR2 may be seated in the second protrusion groove PH2 formed in one side surface of the sixth housing side portion 1126. Further, when performing an X-axis tilt, the second protruding portions PR2a and PR2b may be reference axes (or rotation axes) of the tilt. Accordingly, the tilting guide unit 1141 and the mover 1130 may move in the second direction.

Additionally, the first Hall sensor 1153a may be positioned on an outer side for electrical connection and coupling to the board unit 1154 as described above. However, the present invention is not limited to this position.

Additionally, the third coil 1152c may be located on the third housing side portion 1123, and the third magnet 1151c may be located on the third holder outer surface 1131S3 of the holder 1131. The third coil 1152c and the third magnet 1151c may at least partially overlap in the first direction (X-axis direction). Accordingly, the strength of an electromagnetic force between the third coil 1152c and the third magnet 1151c may be easily controlled.

The tilting guide unit 1141 may be located on the fourth holder outer surface 1131S4 of the holder 1131 as described above. Furthermore, the tilting guide unit 1141 may be seated in the fourth seating groove 1131S4a on the fourth holder outer surface. As described above, the fourth seating groove 1131S4a may include the first region AR1, the second region AR2, and the third region AR3 described above.

The coupling member 1131a may be disposed in the first region AR1, and the coupling member 1131a may include the first groove gr1 formed on an inner surface. Further, the elastic member 1142 may be disposed in the first groove gr1 as described above, and an elastic restoring force RF2 generated by the elastic member 1142 may be transmitted to the fourth seating groove 1131S4 of the holder 1131 through the coupling member 1131a (RF2′). Accordingly, the holder 1131 may apply a force to the tilting guide unit 1141 in a direction the same as that of the elastic restoring force RF2 generated by the elastic member 1142.

The sixth housing side portion 1126 may be disposed in the second region AR2. The sixth housing side portion 1126 may include the second groove gr2 that faces the first groove gr1. Furthermore, the sixth housing side portion 1126 may include the second protrusion groove PH2 disposed in a surface corresponding to the second groove gr2. Further, the elastic restoring force RF1 generated by the elastic member 1142 may be applied to the sixth housing side portion 1126. Accordingly, the sixth housing side portion 1126 and the coupling member 1131a may press the tilting guide unit 1141 disposed between the sixth housing side portion 1126 and the holder 1131 using the generated elastic restoring forces RF1 and RF2′. Accordingly, the coupling between the holder 1131, the housing 1120, and the tilting guide unit 1141 may be maintained even after the holder is tilted with respect to the X-axis or tilted with respect to the Y-axis by a current applied to the first, second, or third coil 1152c.

As described above, the mover 1130 may include the optical member 1132, the holder 1131 coupled to the optical member 1132, and the coupling member 1131a coupled to the holder 1131. Accordingly, the tilting guide unit 1141 may be brought into close contact with the sixth housing side portion and the holder 1131 by the elastic restoring force of the elastic member 1142. Further, the coupling member 1131a may press the sixth housing side portion and the tilting guide unit 1141 in the third direction. Additionally, the coupling member 1131a may press the housing in the opposite direction of the third direction.

The tilting guide unit 1141 may be disposed in the third region AR3. The tilting guide unit 1141 may include the first protruding portion PRI and the second protruding portion PR2, as described above. In this case, the first protruding portion PR1 and the second protruding portion PR2 may be disposed on the second surface and the first surface of the base BS, respectively. In this way, in other embodiments described below, the first protruding portion PR1 and the second protruding portion PR2 may be variously positioned on facing surfaces of the base BS.

The first protrusion groove PH1 may be located in the fourth seating groove. Further, the first protruding portion PR1 of the tilting guide unit 1141 may be accommodated in the first protrusion groove PH1. Accordingly, the first protruding portion PR1 may come into contact with the first protrusion groove PH1. A maximum diameter of the first protrusion groove PH1 may correspond to a maximum diameter of the first protruding portion PR1. This may be equally applied to the second protrusion groove PH2 and the second protruding portion PR2. That is, a maximum diameter of the second protrusion groove PH2 may correspond to a maximum diameter of the second protruding portion PR2. Furthermore, thus, the second protruding portion PR2 may come into contact with the second protrusion groove PH2. With this configuration, the first axis tilt based on the first protruding portion PR1 and the second axis tilt based on the second protruding portion PR2 can easily occur, and the radii of the tilts can be improved.

In addition, the tilting guide unit 1141 may be disposed parallel to the coupling member 1131a and the sixth housing side portion 1126 in the third direction (Z-axis direction) so that the tilting guide unit 1141 overlaps the optical member 1132 in the first direction (X-axis direction). More specifically, in an embodiment, the first protruding portion PR1 may overlap the optical member 1132 in the first direction (X-axis direction). Furthermore, the first protruding portion PR1 may at least partially overlap the third coil 1152c or the third magnet 1151c in the first direction (X-axis direction). That is, in the camera actuator according to the embodiment, each of the protruding portions, which is a center axis of the tilt, may be positioned adjacent to the center of gravity of the mover 1130. Thus, the tilting guide unit may be positioned adjacent to the center of gravity of the holder. Accordingly, the camera actuator according to the embodiment may minimize a moment value for tilting the holder and may also minimize an amount of consumption of current applied to a coil unit or the like to tilt the holder, thereby improving the power consumption and reliability of the element.

In addition, the elastic member 1142 may not overlap the third coil 1152c or the optical member 1132 in the first direction (X-axis direction). In other words, in an embodiment, the elastic member 1142 may be disposed spaced apart from the third coil 1152c or the optical member 1132 in the third direction (Z-axis direction). Accordingly, the camera actuator according to the embodiment may easily perform up and down driving (Y-axis tilt) and minimize power consumption.

Furthermore, as described above, the second Hall sensor 1153b located inside the third coil 1152c may detect a change in magnetic flux, thereby enabling position sensing between the third magnet 1151c and the second Hall sensor 1153b.

In the first camera actuator according to the embodiment, the coupling member 1131a, the elastic member 1142, the sixth housing side portion 1126, the tilting guide unit 1141, and the holder 1131 may be disposed in this order in the third direction. However, the coupling member, the sixth housing side portion, the tilting guide unit, and the holder may be disposed in this order because they are located in the coupling member and the sixth housing side portion.

Further, in an embodiment, a separation distance between the elastic member 1142 and the holder 1131 (or the optical member 1132) in the third direction may be greater than a separation distance between the elastic member 1142 and the tilting guide unit 1141. Thus, the second Hall sensor 1153b below the holder 1131 may also be spaced a predetermined distance apart from the elastic member 1142. Accordingly, the second Hall sensor 1153b may minimize the influence of a magnetic field formed from the elastic member 1142, thereby inhibiting a Hall voltage from being concentrated positively or negatively and becoming saturated. That is, this configuration allows a Hall electrode to have a range over which Hall calibration may be performed. Furthermore, although a temperature is affected by an electrode of the Hall sensor and the resolution of a camera lens varies depending on the temperature, in an embodiment, compensation for the resolution of the lens may be performed accordingly by inhibiting a case where a Hall voltage is concentrated positively or negatively so that a decrease in resolution may be easily inhibited.

Additionally, a circuit design for compensating for an offset in an output (that is, Hall voltage) of the second Hall sensor 1153b may also be easily achieved.

Additionally, according to the embodiment, some regions of the tilting guide unit 1141 with respect to the fourth holder outer surface of the holder 1131 may be located outside the fourth holder outer surface.

The tilting guide unit 1141 may be seated in the fourth seating groove 1131S4a based on the base BS, except for the first protruding portion PR1 and the second protruding portion PR2. In other words, a length of the base BS in the third direction (Z-axis direction) may be smaller than a length of the fourth seating groove 1131S4a in the third direction (Z-axis direction). With this configuration, miniaturization can be easily achieved.

Furthermore, a maximum length of the tilting guide unit 1141 in the third direction (Z-axis direction) may be greater than the length of the fourth seating groove 1131S4a in the third direction (Z-axis direction). Accordingly, as described above, an end of the second protruding portion PR2 may be located between the fourth holder outer surface and the sixth housing side portion 1126. That is, at least a part of the second protruding portion PR2 may be located in a direction opposite to the third direction (Z-axis direction) of the holder 1131. In other words, the holder 1131 may be spaced a predetermined distance apart from the end of the second protruding portion PR2 (a portion coming into contact with the second protrusion groove) in the third direction (Z-axis direction).

Additionally, a front surface 1131aes of the coupling member 1131a according to the embodiment may be spaced apart from a front surface 1126es of the sixth housing side portion 1126. Particularly, the front surface 1131aes of the coupling member 1131a according to the embodiment may be located in the third direction (Z-axis direction) from the front surface 1126es of the sixth housing side portion 1126. Alternatively, the front surface 1131aes of the coupling member 1131a according to the embodiment may be located inside the front surface 1126es of the sixth housing side portion 1126. For this purpose, the sixth housing side portion 1126 may have a structure that extends inward and is bent. Additionally, some regions of the coupling member 1131a may be located in a groove formed by the above-described structure in which the sixth housing side portion 1126 extends and is bent.

With this configuration, the coupling member 1131a may be located inside the sixth housing side portion 1126, thereby improving space efficiency and realizing miniaturization. Furthermore, since the coupling member 1131a does not protrude outside the sixth housing side portion 1126 even when driving by an electromagnetic force (tilting or rotation of the mover 1130) is performed, the contact with surrounding elements may be blocked. In this way, reliability may be improved.

Furthermore, the elastic member 1142 may include the first elastic member 1142a and the second elastic member 1142b disposed spaced apart in the second direction. The first elastic member 1142a and the second elastic member 1142b may overlap in the second direction. The first elastic member 1142a and the second elastic member 1142b may be disposed between the first through hole and the second through hole.

Furthermore, the first protruding portion PR1 may overlap the mover groove MVG in the optical axis direction. As described above, the reliability of the camera actuator may be improved.

Furthermore, a height of the first protrusion groove PH1 may be greater than a height of the mover groove MVG. The height of the first protrusion groove PH1 may correspond to a length of the first protrusion groove PH1 in the third direction. Furthermore, the height of the mover groove MVG may correspond to a length of the mover groove MVG in the third direction.

The second groove gr2 may overlap the first groove gr1 in the third direction (Z-axis direction). Accordingly, the efficiency of the elastic restoring force may increase.

Furthermore, the first groove gr1 and the second groove gr2 may overlap the second protruding portion PR2 in the third direction. Accordingly, the efficiency of the axis rotation may be improved.

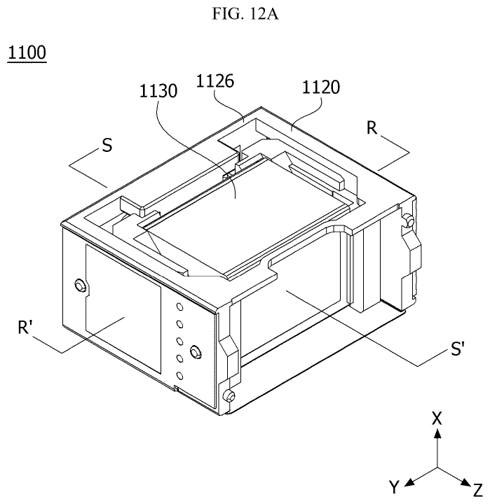

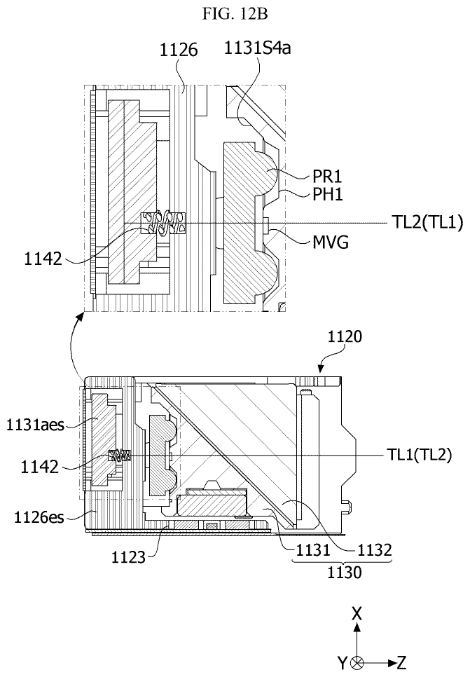

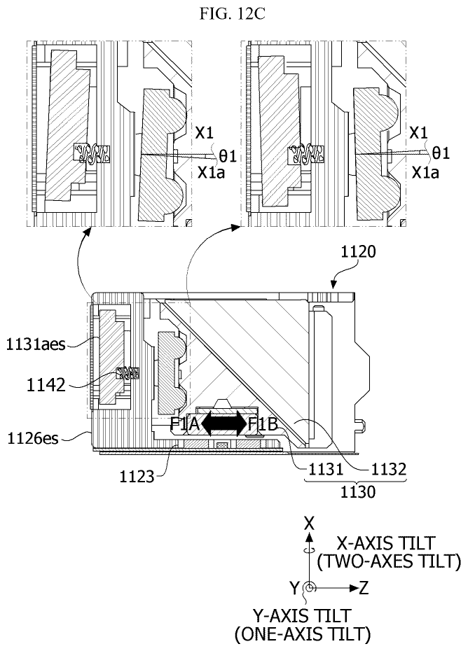

FIG. 12A is a perspective view of the first camera actuator according to the embodiment, FIG. 12B is a cross-sectional view along line SS′ in FIG. 12A, and FIG. 12C is a view showing an example of movement of the first camera actuator shown in FIG. 12B.

Referring to FIGS. 12A to 12C, the Y-axis tilt may be performed in the first camera actuator according to the embodiment. That is, OIS may be implemented by rotating in the first direction (X-axis direction).

In an example, the third magnet 1151c disposed below the holder 1131 may form an electromagnetic force with the third coil 1152c to tilt or rotate the mover 1130 with respect to the second direction (Y-axis direction).

Specifically, the elastic restoring force of the elastic member 1142 may be transmitted to the coupling member 1131a and the sixth housing side portion 1126 and may be finally transmitted to the tilting guide unit 1141 disposed between the sixth housing side portion 1126 and the holder 1131. Accordingly, the tilting guide unit 1141 may have a holding force.

Furthermore, the second protruding portion PR2 may be supported by the sixth housing side portion 1126. In this case, in an embodiment, the tilting guide unit 1141 may rotate or tilt using the second protruding portion PR2 protruding toward the sixth housing side portion 1126 as a reference axis (or rotation axis), that is, with respect to the second direction (Y-axis direction). In other words, the tilting guide unit 1141 may rotate or tilt in the first direction (X-axis direction) using the second protruding portion PR2 protruding toward the sixth housing side portion 1126 as a reference axis (or rotation axis).

For example, OIS may be implemented by rotating the mover 1130 in the X-axis direction by a first angle θ1 (X1→X1a or X1b) using first electromagnetic forces F1A and F1B between the third magnet 1151c disposed in the third seating groove and the third coil unit 1152c disposed on the third board side portion.

In the first camera actuator according to the various embodiments below, the electromagnetic force may generate a force in the described direction to move the mover, or may move the mover in the described direction even though the electromagnetic force generates a force in a different direction. That is, the described direction of the electromagnetic force refers to a direction of a force generated by the magnet and coil to move the mover.

Additionally, centers of the first groove and the second groove may be disposed parallel to each other in the optical axis direction. That is, the center of the first groove and the center of the second groove may be located on a line perpendicular to the optical axis direction.

Further, a bisecting line TL2 bisecting the second protruding portion PR2 and corresponding to the third direction (Z-axis direction) may be parallel to a center line TL1 of the elastic member 1142. In other words, the bisecting line TL2 may be a line bisecting the second protruding portion PR2 in the first direction (X-axis direction), and a plurality of bisecting lines TL2 may be provided.

In an embodiment, this bisecting line TL2 may be a line that is the same as the center line TL1.

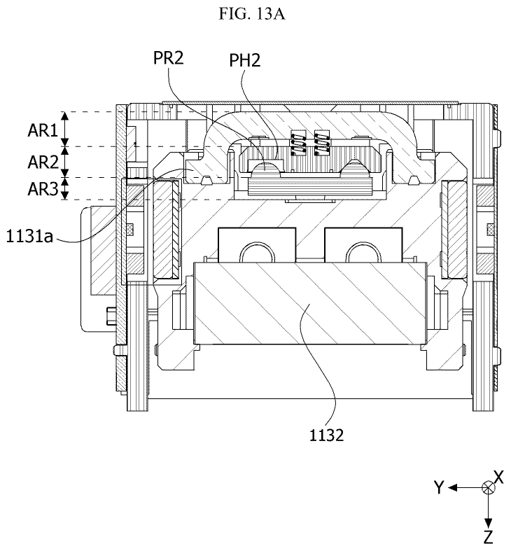

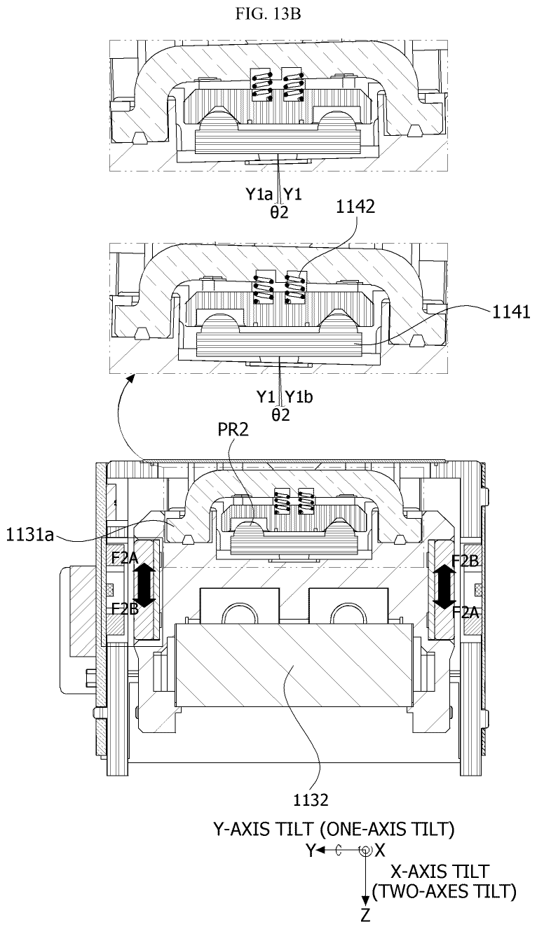

FIG. 13A is a cross-sectional view along line RR′ in FIG. 12A, and FIG. 13B is a view showing an example of movement of the first camera actuator shown in FIG. 13A.

Referring to FIGS. 13A and 13B, the X-axis tilt may be performed. That is, OIS may be implemented while the mover 1130 tilts or rotates in the Y-axis direction.

In an example, the first magnet 1151a and the second magnet 1151b disposed in the holder 1131 may form electromagnetic forces with the first coil 1152a and the second coil 1152b, respectively, to tilt or rotate the tilting guide unit 1141 and the mover 1130 with respect to the first direction (X-axis direction).

Further, the 1-1 protruding portion PR1a and the 1-2 protruding portion PR1b may be spaced apart in the first direction (X-axis direction) and may be supported by the first protrusion groove PH1 formed in the fourth seating groove 1131S4a of the holder 1131. Further, in an embodiment, the tilting guide unit 1141 may rotate or tilt using the first protruding portion PR1 protruding toward the holder 1131 (for example, toward the third direction) as a reference axis (or rotation axis), that is, with respect to the first direction (X-axis direction).

For example, OIS may be implemented by rotating the mover 1130 by a second angle 02 in the Y-axis direction (Y1→Y1a or Y1b) using second electromagnetic forces F2A and F2B between the first and second magnets 1151a and 1151b disposed in the first seating groove and the first and second coil units 1152a and 1152b disposed on the first and second board side portions. In addition, OIS may be implemented by rotating the mover 1130 by the second angle θ2 in the Y-axis direction (Y1→Y1b) using the second electromagnetic forces F2A and F2B between the first and second magnets 1151a and 1151b disposed in the first seating groove and the first and second coil units 1152a and 1152b disposed on the first and second board side portions. The second angle θ2 may be ±1° to 3°.

Further, an electromagnetic force may be applied to the first coil 1152a in the third direction, and an electromagnetic force may be applied to the second coil 1152b in a direction opposite to the third direction. In this case, the first magnet 1151a and the second magnet 1151b may move in the illustrated directions F2B and F2A by receiving forces due to electromagnetic forces. That is, the electromagnetic forces by the first and second magnets 1151a and 1151b and the first and second coil units 1152a and 1152b may act in the third direction or the direction opposite to the third direction. For example, the electromagnetic force may be generated in the third direction (Z-axis direction) on the left side of the mover 1130 and may act in a direction opposite to the third direction (Z-axis direction) on the right side of the mover 1130. Accordingly, the mover 1130 may rotate with respect to the first direction. Alternatively, the mover 1130 may move in the second direction.

In this way, the second actuator according to the embodiment may control the rotation of the mover 1130 in the first direction (X-axis direction) or the second direction (Y-axis direction) by the electromagnetic force between the driving magnet in the holder and the driving coil disposed in the housing, thereby minimizing the occurrence of decentering or tilt phenomena when implementing OIS and providing the best optical characteristics. Additionally, as described above, the ‘Y-axis tilt’ means rotating or tilting in the first direction (X-axis direction), and the ‘X-axis tilt’ means rotating or tilting in the second direction (Y-axis direction).

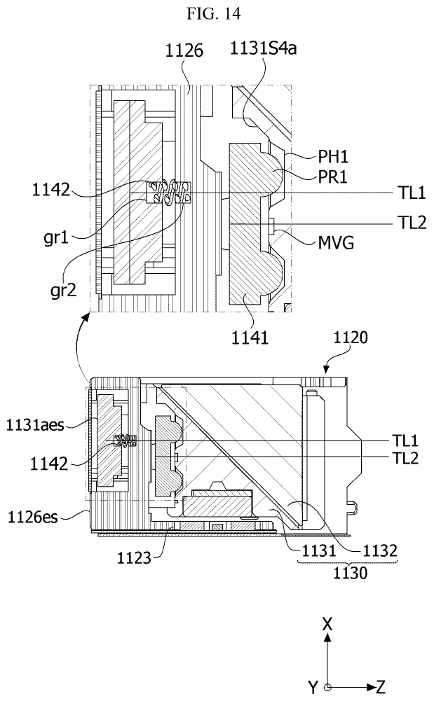

FIG. 14 is a cross-sectional view of a first camera actuator according to another embodiment.

Referring to FIG. 14, the first camera actuator according to another embodiment may include a housing, a mover, a rotating unit, a driving unit, a sixth housing side portion, a coupling member, and a plate. In this embodiment, it should be understood that the description of the housing, the mover, the rotating unit, the driving unit, the sixth housing side portion, the coupling member, and the plate may be equally applied to the contents of the housings, the movers, the rotating units, the driving units, the sixth housing side portions, the coupling members, and the plates of the first camera actuators according to various embodiments described in this specification, when there is no contradiction.

In this embodiment, a first groove gr1 may overlap a line bisecting a coupling member 1131a in the first direction. Accordingly, a bisecting line TL2 bisecting a second protruding portion PR2 and corresponding to the third direction (Z-axis direction) may be parallel to a center line TL1 of an elastic member 1142. Additionally, the bisecting line TL2 may be a line bisecting the second protruding portion PR2 in the first direction (X-axis direction), and a plurality of bisecting lines TL2 may be provided. In an example, the bisecting line TL2 may be spaced apart from the center line TL1 in the first direction (X-axis direction). With this configuration, the bisecting line TL2 may be located below the center line TL1. With this configuration, a great elastic pressure may be applied to one region of a tilting guide unit 1141. Accordingly, the holder may tilt more precisely with respect to the Y-axis or one axis.

Furthermore, the first groove gr1 and a second groove gr2 may be offset from the second protruding portion PR2 in the third direction. The first groove gr1 and the second groove gr2 may not overlap the second protruding portion PR2 in the third direction.

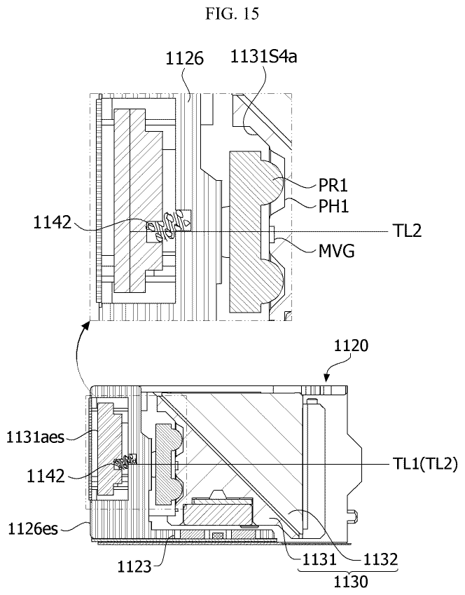

FIG. 15 is a cross-sectional view of a first camera actuator according to still another embodiment.

Referring to FIG. 15, the first camera actuator according to still another embodiment may include a housing, a mover, a rotating unit, a driving unit, a sixth housing side portion, a coupling member, and a plate. In this embodiment, it should be understood that the description of the housing, the mover, the rotation unit, the driving unit, the sixth housing side portion, the coupling member, and the plate may be equally applied to the contents of the housings, the movers, the rotating units, the driving units, the sixth housing side portion, the coupling members, and the plate of the first camera actuator according to various embodiments described in this specification, when there is no contradiction.

A first groove gr1 may partially overlap a second groove gr2 in the third direction (Z-axis direction). Additionally, the first groove gr1 may be partially offset from the second groove gr2 in the third direction (Z-axis direction). That is, the first groove gr1 may not partially overlap the second groove gr2 in the third direction (Z-axis direction). With this configuration, the direction or magnitude of an elastic restoring force may suitably vary depending on a position between a mover 1130 and a tilting guide unit 1141.

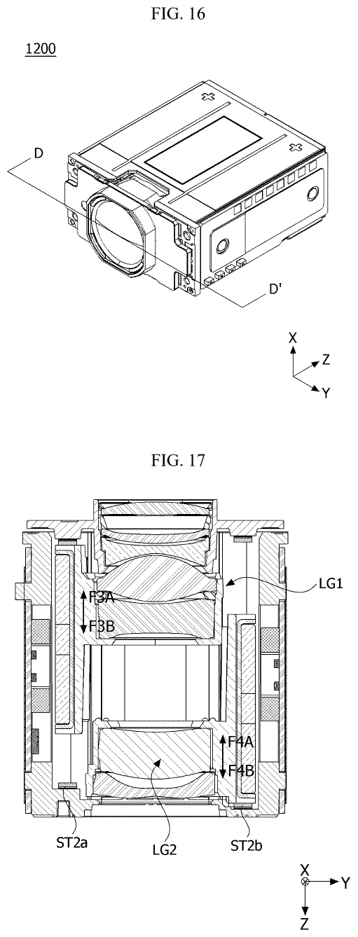

FIG. 16 is a perspective view of a second camera actuator according to the embodiment, and FIG. 17 is a cross-sectional view along line DD′ in FIG. 16.

Referring to FIGS. 16 and 17, the second camera actuator 1200 according to the embodiment may include one or a plurality of lenses LG1 and LG2 as described above.

The second camera actuator may include a driving unit and move at least one of the plurality of lenses in the optical axis direction or the third direction (Z-axis direction) by the driving unit. Depending on driving forces F3A, F3B, F4A, and F4B by the driving unit, the lenses LG1 and LG2 may move individually or together. In an embodiment, the lenses may each move in the optical axis direction.

FIG. 18 is a schematic diagram showing a circuit board according to the embodiment.

Referring to FIG. 18, as described above, a circuit board 1300 according to the embodiment may include a first circuit board unit 1310 and a second circuit board unit 1320. The first circuit board unit 1310 may be located below a base and may be coupled to the base. Furthermore, an image sensor IS may be disposed on the first circuit board unit 1310. Further, the first circuit board unit 1310 and the image sensor IS may be electrically connected. That is, the base may be located at a rear end of the second camera actuator, and the image sensor and the circuit board (first circuit board unit) may be located at a rear end of the base. The base may include a filter (for example, an infrared filter or the like).

Additionally, the second circuit board unit 1320 may be located on a side portion of the base. Particularly, the second circuit board unit 1320 may be located on a first side portion of the base. Accordingly, the second circuit board unit 1320 may be positioned adjacent to a fourth coil positioned adjacent to the first side portion so that electrical connection thereof is easily made. Additionally, the second circuit board unit 1320 may be located on a second side portion. In this way, a plurality of second circuit board units 1320 may be provided. However, the present invention is not limited thereto and the second circuit board unit 1320 may be disposed on only one of the first side portion and the second side portion.

In addition, the circuit board 1300 may additionally include a fixed board (not shown) located on a side surface thereof. Thus, even when the circuit board 1300 is made of a flexible material, the circuit board 1300 may be coupled to the base while maintaining rigidity due to the fixed board.

The second circuit board unit 1320 of the circuit board 1300 may be located on a side portion of the driving unit of the second camera actuator. The circuit board 1300 may be electrically connected to a driving unit of the first camera actuator and the driving unit of the second camera actuator. For example, electrical connection may be made using SMT. However, the present invention is not limited to this method.

The circuit board 1300 may include a circuit board having electrically connectable wiring patterns, such as a rigid printed circuit board (rigid PCB), a flexible printed circuit board (flexible PCB), and a rigid flexible printed circuit board (rigid flexible PCB). However, the present invention is not limited to these types.

Additionally, the circuit board 1300 may be electrically connected to another camera module in a terminal or to a processor of the terminal. Through this, the above-described camera actuator and the camera device including the same may transmit and receive various signals in the terminal.

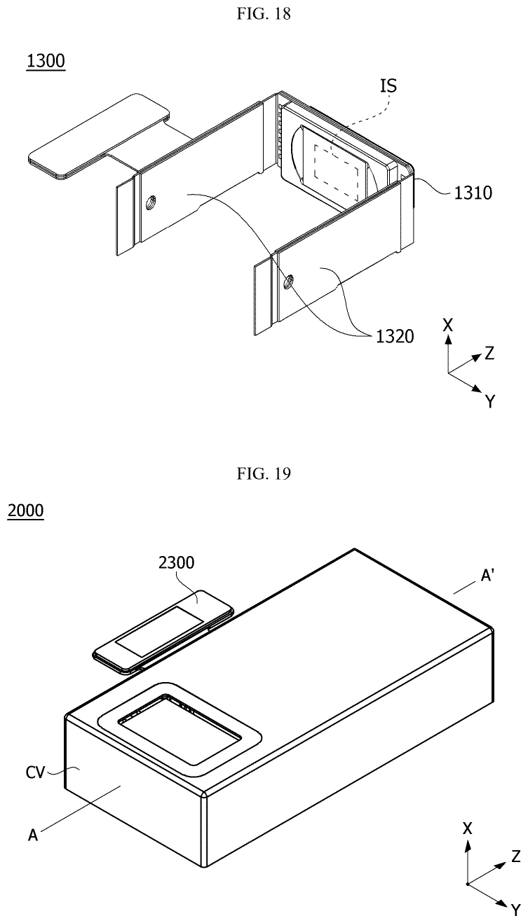

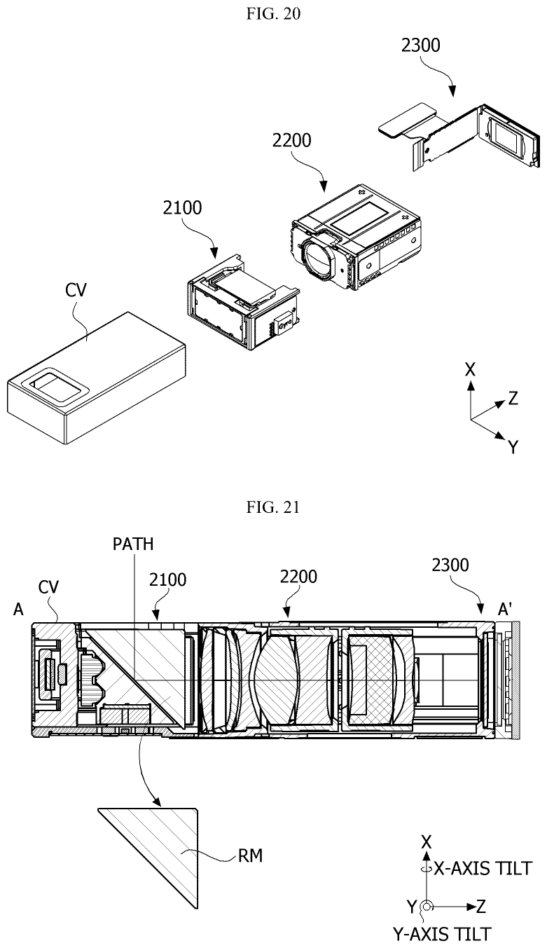

FIG. 19 is a perspective view of a camera module according to the embodiment, FIG. 20 is an exploded perspective view of the camera module according to the embodiment, and FIG. 21 is a view along line AA′ in FIG. 19.

Referring to FIGS. 19 and 20, a camera module 2000 according to the embodiment may include a cover CV, a first camera actuator 2100, a second camera actuator 2200, and a circuit board 2300. Here, the first camera actuator 2100 may be used interchangeably with a first actuator, and the second camera actuator 2200 may be used interchangeably with a second actuator.

The cover CV may cover the first camera actuator 2100 and the second camera actuator 2200. A coupling force between the first camera actuator 2100 and the second camera actuator 2200 may be improved by the cover CV.

Furthermore, the cover CV may be made of a material that performs electromagnetic shielding. Thus, the first camera actuator 2100 and the second camera actuator 2200 in the cover CV may be easily protected.

Further, the first camera actuator 110 may be an optical image stabilization (OIS) actuator. For example, the first camera actuator 2100 may move an optical member in a direction perpendicular to the optical axis (the axis of incident light).

The first camera actuator 2100 may include a fixed focal length lens disposed in a predetermined barrel (not shown). The fixed focal length lens may also be referred to as a “single focal length lens” or a “prime lens.”

The first camera actuator 2100 may change an optical path. In an embodiment, the first camera actuator 2100 may vertically change the optical path through an internal optical member (for example, a prism or a mirror). For example, the optical member may change a direction of light from the first direction (X-axis direction) to the third direction (Z-axis direction). Alternatively, the optical member may change an axis of light from a first axis to a second axis. With this configuration, a configuration of lenses having sizes greater than a thickness of a mobile terminal may be disposed in the mobile terminal to perform magnification, auto-focus (AF), zoom, and OIS functions, even though the thickness of the mobile terminal is reduced, by changing the optical path.

However, the present invention is not limited thereto and the first camera actuator 2100 may change the optical path vertically or at a predetermined angle multiple times.

The second camera actuator 2200 may be disposed at a rear end of the first camera actuator 2100. The second camera actuator 2200 may be coupled to the first camera actuator 2100. Further, the second camera actuator 2200 and the first camera actuator 2100 may be coupled in various ways.

Furthermore, the second camera actuator 2200 may be a zoom actuator or an AF actuator. For example, the second camera actuator 2200 may support one or a plurality of lenses and move the lenses in response to a control signal from a predetermined control unit to perform an auto-focus function or a zoom function.

Further, one or the plurality of lenses may move independently or individually in the optical axis direction and the circuit board 2300 may be disposed at a rear end of the second camera actuator 2200. The circuit board 2300 may be electrically connected to the second camera actuator 2200 and the first camera actuator 2100. Additionally, a plurality of circuit boards 2300 may be provided.

The camera module according to the embodiment may be provided as one or a plurality of camera modules. For example, the plurality of camera modules may include a first camera module and a second camera module.

Further, the first camera module may include one or a plurality of actuators. For example, the first camera module may include the first camera actuator 2100 and the second camera actuator 2200.

Further, the second camera module may be disposed in a predetermined housing (not shown) and may include an actuator (not shown) capable of driving a lens unit. The actuator may be a voice coil motor, a micro actuator, a silicon actuator, or the like and applied in various ways such as capacitive, thermal, bimorph, and electrostatic methods, but is not limited thereto. In addition, in this specification, the camera actuator may be referred to as an actuator or the like. In addition, a camera module composed of a plurality of camera modules may be installed in various electronic devices, such as mobile terminals. Furthermore, the actuator may be a device for moving or tilting a lens and an optical member. Here, in the following description, the actuator is described as a concept in which the actuator includes a lens or an optical member. Furthermore, the actuator may be referred to as a ‘lens transfer device,’ a ‘lens movement device,’ an ‘optical member transfer device,’ an ‘optical member movement device,’ or the like.

Referring to FIG. 21, the camera module according to the embodiment may include the first camera actuator 2100 that performs an OIS function and the second camera actuator 2200 that performs zoom and AF functions.

Light may be incident into the camera module or the first camera actuator through an opening region located in an upper surface of the first camera actuator 2100. That is, light may be first incident into the first camera actuator 2100 in the optical axis direction (for example, X-axis direction, based on incident light), and the optical path may be changed to the optical axis direction (for example, Z-axis direction) through the optical member. Further, light may pass through the second camera actuator 2200 and may be incident on an image sensor IS located at one end of the second camera actuator 2200 (PATH). In this specification, the Z-axis direction or the third direction is described as the optical axis direction as follows.

In this specification, a bottom surface means one side in the first direction. Further, the first direction is the X-axis direction in the drawings and may be used interchangeably with a second-axis direction or the like. The second direction is the Y-axis direction in the drawings and may be used interchangeably with a first-axis direction or the like. The second direction is a direction perpendicular to the first direction. Additionally, the third direction is the Z-axis direction in the drawings, and may be used interchangeably with a third-axis direction or the like. Further, the third direction is a direction perpendicular to both the first and second directions. Here, the third direction (Z-axis direction) corresponds to the direction of the optical axis, and the first direction (X-axis direction) and the second direction (Y-axis direction) are directions perpendicular to the optical axis. Additionally, in the following description, in the description of the first and second camera actuators, the optical axis direction is the third direction (Z-axis direction), and the following description is made based on this.

Furthermore, in this specification, an inner side may be a side in a direction from the cover CV toward the first camera actuator, and an outer side may be a side in a direction opposite to that of the inner side. That is, the first camera actuator and the second camera actuator may be located inside the cover CV, and the cover CV may be located outside the first camera actuator or the second camera actuator.

Further, with this configuration, the camera module according to the embodiment may improve the spatial limitations of the first camera actuator and the second camera actuator by changing the optical path. That is, the camera module according to the embodiment may expand the optical path while minimizing the thickness of the camera module in response to a change in the optical path. Furthermore, it should be understood that the second camera actuator can also provide a high range of magnification by controlling a focus or the like in the expanded optical path.

Furthermore, the camera module according to the embodiment can implement OIS through control of the optical path via the first camera actuator, thereby minimizing the occurrence of decentering or tilt phenomena and producing the best optical characteristics.

Furthermore, the second camera actuator 2200 may include an optical system and a lens driving unit. For example, at least one of a first lens assembly, a second lens assembly, and a third lens assembly may be disposed in the second camera actuator 2200.

Also, the second camera actuator 2200 may include a coil and a magnet to perform a high magnification zoom function and an auto-focus function.

For example, although the first lens assembly and the second lens assembly may be moving lenses that move via coils, magnets, and guide pins, and the third lens assembly may be a fixed lens, the present invention is not limited thereto. For example, the third lens assembly may function as a focator that forms an image by focusing light on a specific location, and the first lens assembly may function as a variator that reforms the image formed in the third lens assembly, which is a focator, on a different location. Meanwhile, the first lens assembly may have a significant change in magnification due to a significant change in a distance to the subject or an image distance, and the first lens assembly, which is a variator, may play an important role in the focal length or magnification change of the optical system. Meanwhile, an image point that is formed in the first lens assembly, which is a variator, may vary slightly depending on the location thereof. Thus, the second lens assembly may perform a location compensation function for the image formed using the variator. For example, the second lens assembly may function as a compensator, which functions to accurately form the image point formed in the first lens assembly, which is a variator, on an actual position of the image sensor. For example, the first lens assembly and the second lens assembly may be driven using an electromagnetic force due to the interaction of the coil and the magnet. The above description can be applied to the lens assembly which will be described below. Furthermore, the first lens assembly to the third lens assembly may move in the optical axis direction, that is, the third direction. Further, the first lens assembly to the third lens assembly may move in the third direction independently or dependently. In the present invention, the first lens assembly and the second lens assembly may move in the optical axis direction. Further, the third lens assembly may be located at a front end of the first lens assembly or at a rear end of the second lens assembly. Further, the third lens assembly may not move in the optical axis direction. That is, the third lens assembly may be a fixed unit. Furthermore, the first and second lens assemblies may be moving units.

Meanwhile, when an actuator for OIS and an actuator for AF/zoom are disposed in accordance with the embodiment of the present invention, magnetic interference with a magnet for AF/zoom may be inhibited when driving the OIS. Since a first driving magnet of the first camera actuator 2100 is disposed separately from the second camera actuator 2200, magnetic interference between the first camera actuator 2100 and the second camera actuator 2200 may be inhibited. In this specification, OIS may be interchangeably referred to as the terms such as image stabilization, optical image stabilization, optical image correction, and shake correction.

Particularly, in the first camera actuator 2100, an optical member RM may be tilted with respect to the X-axis or the Y-axis. Accordingly, it is possible to easily change the optical path in accordance with the X-axis tilt or the Y-axis tilt.

The optical member RM may be seated in a holder of the first camera actuator. In an embodiment, the optical member RM may be formed of a mirror or prism. Although the following description is made based on the optical member RM that is formed of a prism, the optical member RM may also be formed of a plurality of lenses as in the above-described embodiment. Alternatively, the optical member RM may be formed of a plurality of lenses and prisms or mirrors. Further, the optical member RM may include a reflecting unit disposed therein. Here, the present invention is not limited thereto.

In the first camera actuator 2100, the optical member RM may be tilted with respect to the X-axis or the Y-axis by driving a VCM or the like. That is, OIS may be implemented by tilting or rotating the optical member RM with respect to the Y-axis direction or the X-axis direction.

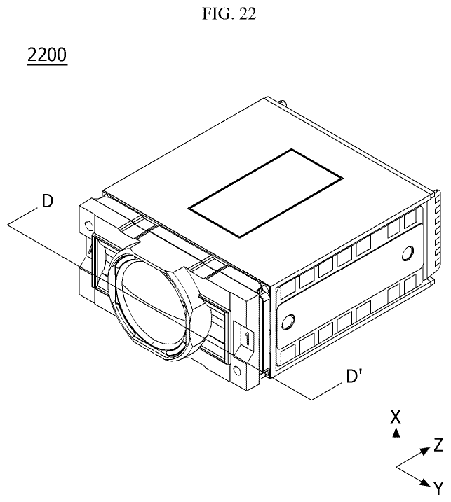

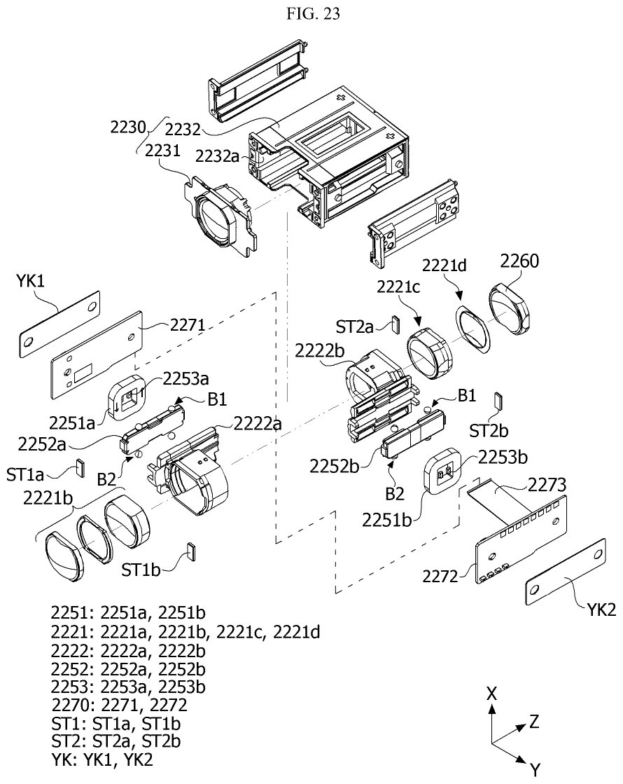

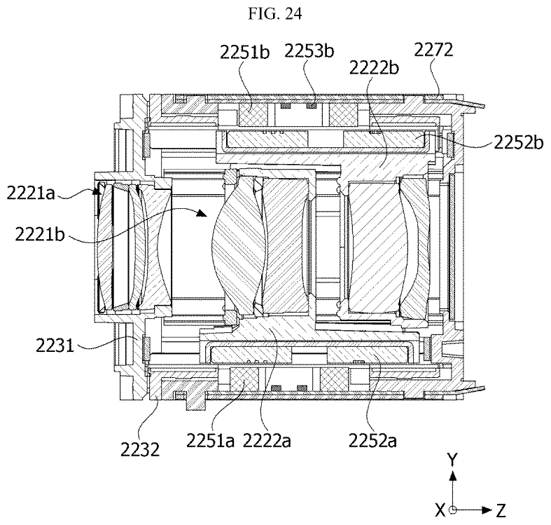

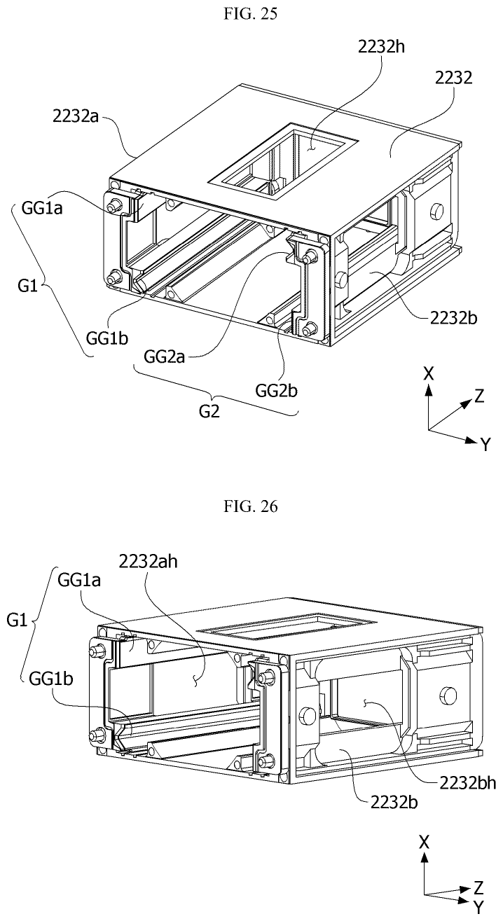

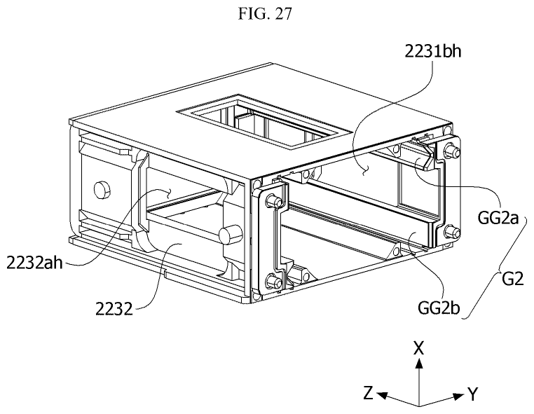

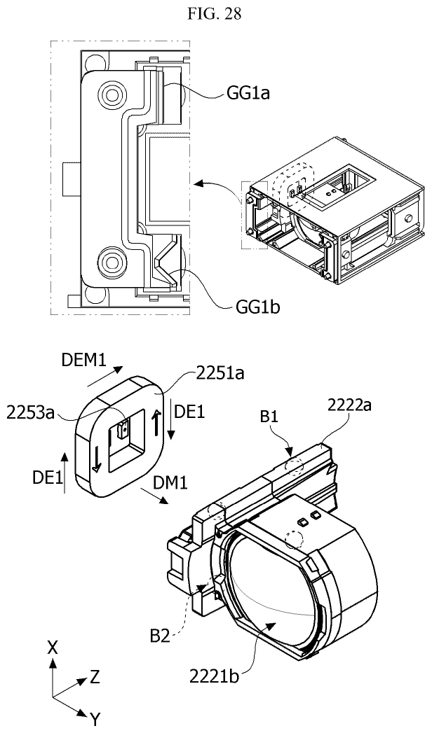

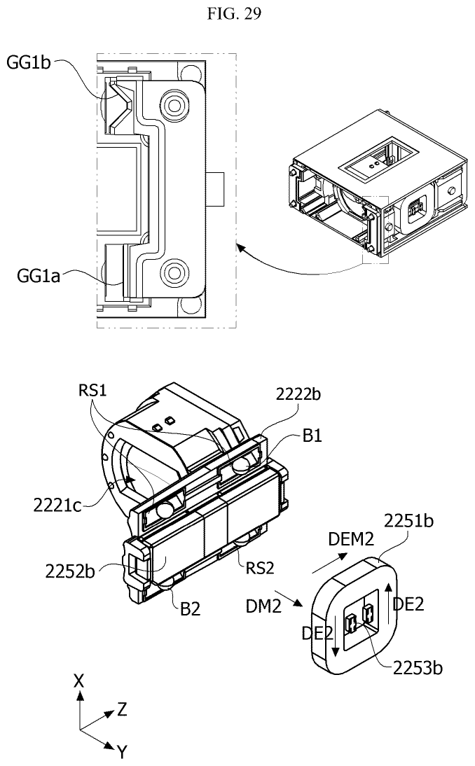

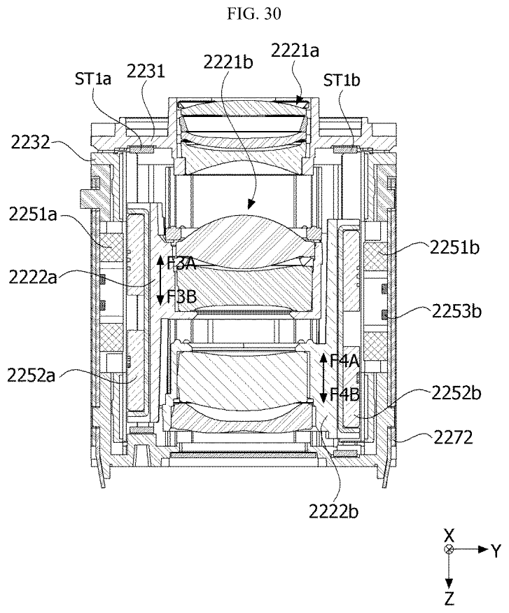

FIG. 22 is a perspective view of the second camera actuator according to the embodiment, FIG. 23 is an exploded perspective view of the second camera actuator according to the embodiment, FIG. 24 is a view along line DD′ in FIG. 22, FIGS. 25, 26, and 27 are perspective views of a second housing in the second camera actuator according to the embodiment, FIGS. 28 and 29 are views for describing each driving of the lens assembly according to the embodiment, and FIG. 30 is a view for describing driving of the second camera actuator according to the embodiment.

Referring to FIGS. 22 to 24, the second camera actuator 2200 according to the embodiment may include a lens unit 2220, a housing 2230, a driving unit 2250, a base portion 2260, a board unit 2270, a bonding member 2280, a stopper portion ST, and a yoke unit YK. Furthermore, the second camera actuator 2200 may further include a shield can (not shown), an elastic unit (not shown), and a bonding member (not shown).

The shield can (not shown) may be located in one region (for example, the outermost side) of the second camera actuator 2200 and may be located to surround components described below (lens unit 2220, housing 2230, driving unit 2250, base portion 2260, and board unit 2270).

The shield can (not shown) may block or reduce electromagnetic waves generated from the outside. Accordingly, the shield can (not shown) may reduce the occurrence of malfunctions in the driving unit 2250.

The lens unit 2220 may be located in the shield can (not shown). The lens unit 2220 may move in the third direction (Z-axis direction or optical axis direction). Accordingly, the AF and zoom functions described above may be performed.

Additionally, the lens unit 2220 may be located in the housing 2230. Accordingly, at least a part of the lens unit 2220 may move in the optical axis direction or the third direction (Z-axis direction) in the housing 2230.

Specifically, the lens unit 2220 may include a lens group 2221 and a moving assembly 2222.

First, the lens group 2221 may include at least one lens. In addition, although a plurality of lens groups 2221 may be provided, the following description will be made based on one lens group 2221.

The lens group 2221 may be coupled to the moving assembly 2222 and may move in the third direction (Z-axis direction) using an electromagnetic force generated from a first magnet 2252a and a second magnet 2252b coupled to the moving assembly 2222.

In an example, the lens group 2221 may include a first lens group 2221a, a second lens group 2221b, and a third lens group 2221c. The first lens group 2221a, the second lens group 2221b, and the third lens group 2221c may be sequentially disposed in the optical axis direction. Furthermore, the lens group 2221 may further include a fourth lens group 2221d. The fourth lens group 2221d may be disposed at a rear end of the third lens group 2221c.

The first lens group 2221a may be fixed by being coupled to a fixed assembly. In other words, the first lens group 2221a may not move in the optical axis direction. The fixed assembly is a fixed assembly, unlike a moving assembly described below.

The second lens group 2221b may be coupled to a first lens assembly 2222a and may move in the third direction or the optical axis direction. Magnification adjustment may be performed by moving the first lens assembly 2222a and the second lens group 2221b.

The third lens group 2221c may be coupled to a second lens assembly 2222b and may move in the third direction or the optical axis direction. Focus adjustment or auto-focus may be performed by moving the third lens group 2221c.

However, the number of lens groups is not limited, and the above-described fourth lens group 2221d may not be present, or an additional lens group other than the fourth lens group 2221d may be further disposed.

The moving assembly 2222 may include an opening region surrounding the lens group 2221. This moving assembly 2222 may be used interchangeably with a lens assembly. Further, the moving assembly 2222 may be coupled to the lens group 2221 in various ways. Additionally, the moving assembly 2222 may include grooves in a side surface and may be coupled to the first magnet 2252a and the second magnet 2252b through the grooves. A coupling member or the like may be applied to the grooves.

Additionally, the moving assembly 2222 may be coupled to elastic units (not shown) at upper and rear ends thereof. Accordingly, the moving assembly 2222 may move in the third direction (Z-axis direction) while supported by the elastic units (not shown). That is, a position of the moving assembly 2222 may be maintained and a direction thereof may be maintained in the third direction. The elastic units (not shown) may be formed as various elastic elements, such as a plate spring.

The moving assembly 2222 may be located in the housing 2230 and may include the first lens assembly 2222a and the second lens assembly 2222b.

A region where the third lens group is seated in the second lens assembly 2222b may be located at a rear end of the first lens assembly 2222a. In other words, the region where the third lens group 1221c is seated in the second lens assembly 2222b may be located between a region where the second lens group 1221b is seated in the first lens assembly 1222a and the image sensor.

The first lens assembly 2222a and the second lens assembly 2222b may each be seated inside the lens barrel. For example, in the first lens assembly 2222a, a recess in which a ball is disposed may be positioned to face a first side portion. Further, the recess in which the ball is disposed in the second lens assembly 2222b may be positioned to face a second side portion. A detailed description thereof will be made below.

Further, the driving magnet may be seated on outer surfaces of the first lens assembly 2222a and the second lens assembly 2222b. For example, the second magnet 2252b may be seated on the outer surface of the second lens assembly 2222b. The first magnet 2252a may be seated on the outer surface of the first lens assembly 2222a.

The housing 2230 may be disposed between the lens unit 2220 and the shield can (not shown). Further, the housing 2230 may be disposed to surround the lens unit 2220.

The housing 2230 may include a fixed assembly 2231 and a lens barrel 2232. The fixed assembly 2231 may be coupled to the first lens group 2221a and may also be coupled to the above-described first camera actuator. The fixed assembly 2231 may be located in front of the lens barrel 2232.

Further, the lens barrel 2232 may be located at a rear end of the fixed assembly 2231. The lens unit 2220 may be seated inside the lens barrel 2232.

The housing 2230 (or lens barrel 2232) may have a hole formed in a side portion. A first coil 2251a and a second coil 2251b may be disposed in the hole. The hole may be positioned to correspond to a groove of the above-described moving assembly 2222.

Further, in another embodiment, first and second guide grooves facing recesses (seating grooves where first and second balls are seated) of the first lens assembly 2222a may be located in a first side portion. Further, first and second guide grooves facing recesses of the second lens assembly 2222b may be located in a second side portion. In this case, a structure in which a separate member (for example, guide unit) including the first and second guide grooves is coupled to the lens barrel 2232 may be provided. However, in this embodiment, the description is made based on an integrated structure in which the first and second guide grooves are formed in the lens barrel 2232. Furthermore, as in other embodiments, the first guide unit and the second guide unit may be positioned to correspond to each other. For example, the first guide unit and the second guide unit may be positioned opposite to each other with respect to the third direction (Z-axis direction). Additionally, the first guide unit and the second guide unit may at least partially overlap each other in the second direction (Y-axis direction).

The first guide unit and the second guide unit may include at least one groove (for example, guide groove) or recess. Further, a first ball B1 or a second ball B2 may be seated in the groove or recess. Accordingly, the first ball B1 or the second ball B2 may move in the third direction (Z-axis direction) in the guide groove of the first guide unit or the guide groove of the second guide unit.

Alternatively, the first ball B1 or the second ball B2 may move in the third direction along a rail formed on an inner side of a first side portion 2232a of the housing 2230 or a rail formed on an inner side of a second side portion 2232b of the housing 2230.

Thus, the first lens assembly 2222a and the second lens assembly 2222b may move in the third direction.

According to the embodiment, the first ball B1 may be disposed on an upper portion of the first lens assembly 2222a or the second lens assembly 2222b. Further, the second ball B2 may be disposed on a lower portion of the first lens assembly 2222a or the second lens assembly 2222b. For example, the first ball B1 may be located above the second ball B2. Thus, the first ball B1 may at least partially overlap the second ball B2 in the first direction (X-axis direction) depending on the positions thereof.

Additionally, the lens barrel 2232 may include first guide grooves GG1a and GG2a (refer to FIGS. 28 and 26) facing a first recess. Additionally, the lens barrel 2232 may include second guide grooves GG1b and GG2b facing a second recess. The first guide grooves GG1a and GG2a and the second guide grooves GG1b and GG2b may be grooves extending in the third direction (Z-axis direction). Further, the first guide grooves GG1a and GG2a and the second guide grooves GG1b and GG2b may be grooves having different shapes. For example, the first guide grooves GG1a and GG2a may be grooves with inclined side surfaces, and the second guide grooves GG1b and GG2b may be grooves with side surfaces perpendicular to a bottom surface.

A first magnet and a first coil may be located on the first side portion. Further, a second magnet and a second coil may be located on the second side portion. Further, the second magnet 2252b may be positioned to face the second coil 2251b. Furthermore, the first magnet 2252a may be positioned to face the first coil 2251a.

The elastic unit (not shown) may include a first elastic member (not shown) and a second elastic member (not shown). The first elastic member (not shown) may be coupled to an upper surface of the moving assembly 2222. The second elastic member (not shown) may be couple to a lower surface of the moving assembly 2222. Furthermore, the first elastic member (not shown) and the second elastic member (not shown) may be formed as a plate spring as described above. Additionally, the first elastic member (not shown) and the second elastic member (not shown) may provide elasticity for movement of the moving assembly 2222. However, the present invention is not limited to the above-described positions, and the elastic unit may be disposed in various positions.

Further, the driving unit 2250 may provide a driving force to move the lens unit 2220 in the third direction (Z-axis direction). The driving unit 2250 may include a driving coil 2251 and a driving magnet 2252. Furthermore, the driving unit 2250 may further include a Hall sensor unit. The Hall sensor unit 2253 may include at least one Hall sensor 2253a and may be located on an inner side or outer side of the driving coil 2251.

The moving assembly may move in the third direction (Z-axis direction) due to the electromagnetic force formed between the driving coil 2251 and the driving magnet 2252.

The driving coil 2251 may include the first coil 2251a and the second coil 2251b. The first coil 2251a and the second coil 2251b may be disposed in holes formed in side portions of the housing 2230. Further, the first coil 2251a and the second coil 2251b may be electrically connected to the board unit 2270. Accordingly, the first coil 2251a and the second coil 2251b may receive a current or the like supplied through the board unit 2270.

The driving magnet 2252 may include the first magnet 2252a and the second magnet 2252b. The first magnet 2252a and the second magnet 2252b may be disposed in the above-described grooves of the moving assembly 2222 and may be positioned to correspond to the first coil 2251a and the second coil 2251b.

The base portion 2260 may be located between the lens unit 2220 and the image sensor IS. A component such as a filter may be fixed to the base portion 2260. Additionally, the base portion 2260 may be disposed to surround the above-described image sensor. With this configuration, since the image sensor is free from foreign matter or the like, the reliability of the element can be improved. However, this configuration is omitted and described in some drawings below. However, the present invention may not be limited to this structure.

Furthermore, the second camera actuator 2200 may be a zoom actuator or an AF actuator. For example, the second camera actuator may support one or a plurality of lenses and move the lenses in response to a control signal from a predetermined control unit to perform at least one of an auto-focus function and a zoom function.

Further, the second camera actuator may be a fixed zoom or a continuous zoom. For example, the second camera actuator may move the lens group 2221.

Furthermore, the second camera actuator may be composed of a plurality of lens assemblies. For example, in the second camera actuator, at least one of a third lens assembly (not shown) and a guide pin (not shown) may be disposed, in addition to the first lens assembly 2222a and the second lens assembly 2222b. The above description can be applied to this. Thus, the second camera actuator may perform a high magnification zoom function via the driving unit. For example, although the first lens assembly 2222a and the second lens assembly 2222b may be moving lenses that move via the driving unit and the guide pin (not shown), and the third lens assembly (not shown) may be a fixed lens, the present invention is not limited thereto. For example, the third lens assembly (not shown) may function as a focator that forms an image by focusing light on a specific location, and the first lens assembly may function as a variator that reforms the image formed in the third lens assembly (not shown), which is a focator, on a different location. Meanwhile, the first lens assembly may have a significant change in magnification due to a significant change in a distance to the subject or an image distance, and the first lens assembly, which is a variator, may play an important role in the focal length or magnification change of the optical system. Meanwhile, an image point that is formed in the first lens assembly, which is a variator, may vary slightly depending on the location thereof. Thus, the second lens assembly may perform a location compensation function for the image formed using the variator. For example, the second lens assembly may function as a compensator, which functions to accurately form the image point formed in the first lens assembly 2222a, which is a variator, on an actual position of the image sensor. However, the configuration of this embodiment is described based on the drawing below.

The image sensor may be located on an inner side or outer side of the second camera actuator. In an embodiment, the image sensor may be located on the outer side of the second camera actuator, as shown in the drawing. For example, the image sensor may be located on the circuit board. The image sensor may receive light and convert the received light into electrical signals. Furthermore, the image sensor may be composed of a plurality of pixels arranged in an array form. Further, the image sensor may be located on the optical axis.

The board unit 1270 may come into contact with a side portion of the housing. For example, the board unit 2270 may be located on an outer surface (first side surface) of the first side portion and an outer surface (second side surface) of the second side portion of the housing, particularly, the lens barrel, and may come into contact with the first side surface and the second side surface.

A stopper portion ST may include a first stopper ST1 disposed at one end in the lens barrel 2232 and a second stopper ST2 disposed at the other end. The first stopper ST1 and the second stopper ST2 may be sequentially disposed in the optical axis direction.

Furthermore, a plurality of first stoppers ST1 may be provided and may each be disposed on a movement path of the first lens assembly and a movement path of the second lens assembly. For convenience, the plurality of first stoppers ST1 are described as a 1-1 stopper ST1a and a 1-2 stopper ST1b. Similarly, a plurality of second stoppers ST2 may be provided and may each be disposed on the movement path of the first lens assembly and the movement path of the second lens assembly. Also, the plurality of second stoppers ST2 are described as a 2-1 stopper ST2a and a 2-2 stopper ST2b.

The 1-1 stopper ST1a and the 2-1 stopper ST2a may be located on the movement path of the first lens assembly. The 1-2 stopper ST1b and the 2-2 stopper ST2b may be located on the movement path of the second lens assembly.

The 1-1 stopper ST1a and the 1-2 stopper ST1b may overlap in the second direction. Alternatively, the 1-1 stopper ST1a and the 1-2 stopper ST1b may be offset in the second direction.

Further, the 2-1 stopper ST2a and the 2-2 stopper ST2b may be positioned offset in the second direction. A distance in the third direction between the 1-1 stopper ST1a and the 2-1 stopper ST2a may be smaller than a distance between the 1-2 stopper ST1b and the 2-2 stopper ST2b. This is a configuration that reflects the fact that a movement distance (stroke) of the first lens assembly is smaller than a movement distance (stroke) of the second lens assembly.

In an example, a second yoke unit or yoke unit YK may be disposed on an outer side of the driving unit. For example, the yoke unit YK may be disposed on an outer side of the first and second coils. The second yoke unit YK may include a first yoke YK1 and a second yoke YK2.

The first yoke YK1 and the second yoke YK2 may be disposed opposite to each other. For example, the first yoke YK1 and the second yoke YK2 may be positioned to correspond to each other with respect to the optical axis.

The first yoke YK1 may be positioned adjacent to the first coil 2251a. The second yoke YK2 may be positioned adjacent to the second coil 2251b. The first coil 2251a and the second coil 2251b may be located on inner sides of the first yoke YK1 and the second yoke YK2. Additionally, the first yoke YK1, the first coil 2251a, the second coil 2251b, and the second yoke YK2 may be sequentially disposed in one direction (for example, the second direction). The first yoke YK1 may form an attractive force with the first magnet. Additionally, the second yoke YK2 may form an attractive force with the second magnet. Accordingly, the postures of the first and second lens assemblies may be maintained.

Furthermore, thicknesses of the first yoke YK1 and the second yoke YK2 may vary in some regions. With this configuration, it is possible to suppress the magnetic force or the like generated by the first and second magnets or the first and second coils from affecting other magnets or coils. For example, the first yoke YK1 may suppress the magnetic force generated by the first magnet from being applied to the second magnet and the second coil.

Referring to FIGS. 25 to 27, as described above, the second housing 2230 (particularly, the 2-2 housing 2232) may include the first side portion 2232a and the second side portion 2232b. The first side portion 2232a and the second side portion 2232b may be positioned to correspond to each other. For example, the first side portion 2232a and the second side portion 2232b may be disposed symmetrically with respect to the third direction. The second driving coil may be located on the first side portion 2232a and the second side portion 2232b. Further, a second board unit may be seated on outer surfaces of the first side portion 2232a and the second side portion 2232b. The second board unit may be located on an outer side of the driving coil and may be electrically connected to the driving coil.

For example, a first board may be located on the outer surface of the first side portion 2232a, and a second board may be located on the outer surface of the second side portion 2232b.

Furthermore, the first guide grooves GG1a and GG1b in which the first ball and the second ball are seated may be located in an inner surface of the first side portion 2232a. The first guide grooves GG1a and GG1b may face the first recess and the second recess described above. Similarly, the second guide grooves GG2a and GG2b in which the first ball and the second ball are seated may be located in an inner surface of the second side portion 2232b.

Furthermore, the first side portion 2232a may include a first side hole 2232ah. The first magnet may be located in the first side hole 2232ah. Furthermore, the first side hole 2232ah may have a smaller length in the second direction than the first coil.

Further, the second side portion 2232b may include a second side hole 2232bh. The fourth magnet may be located in the second side hole 2232bh. Furthermore, the second side hole 2232bh may have a smaller length in the second direction than the second coil.

Furthermore, the 2-2 housing 2232 may include a housing hole 2232h disposed at any one of an upper portion and a lower portion. Through the housing hole 2232h, coupling may be easily achieved or inspection (for example, visual inspection) of the first lens assembly and the second lens assembly may be performed.

Additionally, the first guide grooves GG1a and GG1b located in the first side portion 2232a may extend in the third direction. Furthermore, the first guide grooves GG1a and GG1b may have different shapes. For example, one first guide groove GG1a of the first guide grooves may be an inclined groove and the other first guide groove GG1b may have a flat structure. The same can also apply to the second guide grooves GG2a and GG2b. The first and second balls are seated in the inclined groove and the groove with a flat structure so that the first lens assembly or the second lens assembly may move in the optical axis direction.

Referring to FIGS. 28 and 29, in the camera device according to the embodiment, an electromagnetic force DEM1 between the first magnet 2252a and the first coil 2251a may be generated so that the first lens assembly 2222a moves along a rail located on an inner surface of the housing through the first ball B1 and the second ball B2 in a direction parallel to the optical axis, that is, in the third direction (Z-axis direction) or the direction opposite to the third direction.

Specifically, in the camera device according to the embodiment, the first magnet 2252a may be provided in the first lens assembly 2222a, for example, by a vertical magnetization method. For example, in an embodiment, both an N pole and an S pole of the first magnet 2252a may be positioned to face the first coil 2251a. Accordingly, the N pole and the S pole of the first magnet 2252a may each be disposed to correspond to a region in which current flows in the X-axis direction or a direction opposite thereto in the first coil 2251a.

In an embodiment, when a magnetic force is applied in a direction opposite to the second direction (Y-axis direction) from the N pole of the first magnet 2252a, and a current DE1 flows in a direction opposite to the first direction (X-axis direction) from the first coil 2251a corresponding to the N pole, the electromagnetic force DEM1 may act in the third direction (Z-axis direction) in accordance with the interaction of electromagnetic forces (for example, Fleming's left hand rule).

In addition, in an embodiment, when a magnetic force is applied in the second direction (Y-axis direction) from the S pole of the first magnet 2252a and the current DE1 flows in the first direction (X-axis direction) from the first coil 2251a corresponding to the S pole, the electromagnetic force DEM1 may act in the Z-axis direction in accordance with the interaction of the electromagnetic forces.

At this time, since the first coil 2251a is fixed to a side portion of the second housing, the first lens assembly 2222a in which the first magnet 2252a is disposed may move in the direction opposite to the Z-axis direction by the electromagnetic force DEM1 in accordance with the direction of current. That is, the second driving magnet may move in a direction opposite to that of the electromagnetic force applied to the second driving coil. Also, the direction of the electromagnetic force may be changed depending on the current in the coil and the magnetic force of the magnet.

Accordingly, the first lens assembly 2222a may move along a rail located on the inner surface of the housing through the first ball B1 and the second ball B2 in the third direction or in a direction parallel to the optical axis direction (in both directions). In this case, the electromagnetic force DEM1 may be controlled in proportion to the current DE1 applied to the first coil 2251a.

The first lens assembly 2222a or the second lens assembly 2222b may include a first recess RS1 in which the first ball B1 is seated. Additionally, the first lens assembly 2222a or the second lens assembly 2222b may include a second recess RS2 in which the second ball B2 is seated. A length of the first recess RS1 in the optical axis direction (Z-axis direction) may be set in advance. Furthermore, a length of the second recess RS2 in the optical axis direction (Z-axis direction) may be set in advance. Accordingly, the first ball B1 and the second ball B2 may have movement distances thereof adjusted in the optical axis direction in each of the recesses. In other words, the first recess RS1 or the second recess RS2 may be a stopper for the first and second balls B1 and B2.

Further, in the camera device according to the embodiment, the fourth magnet 2252b may be provided in the second lens assembly 2222b by, for example, a vertical magnetization method. For example, in an embodiment, both an N pole and an S pole of the fourth magnet 2252b may be positioned to face the second coil 2251b. Accordingly, the N pole and the S pole of the fourth magnet 2252b may each be disposed to correspond to a region in which current flows in the X-axis direction or the direction opposite thereto in the second coil 2251b.

In an embodiment, when a magnetic force DM2 is applied in the second direction (Y-axis direction) from the N pole of the fourth magnet 2252b and a current DE2 flows in the first direction (X-axis direction) from the second coil 2251b corresponding to the N pole, an electromagnetic force DEM2 may act in the third direction (Z-axis direction) in accordance with the interaction of electromagnetic forces (for example, Fleming's left hand rule).

In addition, in an embodiment, when a magnetic force is applied in the direction opposite to the second direction (Y-axis direction) from the S pole of the fourth magnet 2252b, and the current DE2 flows in the direction opposite to the first direction (X-axis direction) from the second coil 2251b corresponding to the S pole, the electromagnetic force DEM2 may act in the Z-axis direction in accordance with the interaction of the electromagnetic forces.

At this time, since the second coil 2251b is fixed to a side portion of the second housing, the second lens assembly 2222b in which the fourth magnet 2252b is disposed may move in the direction opposite to the Z-axis direction by the electromagnetic force DEM2 in accordance with the direction of current. For example, as described above, the direction of the electromagnetic force may be changed depending on the current in the coil and the magnetic force of the magnet. Accordingly, the second lens assembly 2222b may move along a rail located on an inner surface of the second housing through the second ball B2 in a direction parallel to the third direction (Z-axis direction). In this case, the electromagnetic force DEM2 may be controlled in proportion to the current DE2 applied to the second coil 2251b.

Referring to FIG. 30, in the camera module according to the embodiment, the driving unit may provide the driving forces F3A, F3B, F4A, and F4B to move the first lens assembly 2222a and the second lens assembly 2222b of the lens unit 2220 in the third direction (Z-axis direction). The driving unit may include the driving coil 2251 and the driving magnet 2252 as described above. Further, the lens unit 2220 may move in the third direction (Z-axis direction) due to the electromagnetic force formed between the driving coil 2251 and the driving magnet 2252.

In this case, the first coil 2251a and the second coil 2251b may be disposed in the holes formed in the side portions (for example, the first side portion and the second side portion) of the housing 2230. Further, the second coil 2251b may be electrically connected to a first board 2271. The first coil 2251a may be electrically connected to a second board 2272. Accordingly, the first coil 2251a and the second coil 2251b may receive a driving signal (for example, current) supplied from a driving driver on a circuit board of the circuit board 2300 through the board unit 2270.

At this time, the first lens assembly 2222a on which the first magnet 2252a is seated may move in the third direction (Z-axis direction) by the electromagnetic forces F3A and F3B between the first coil 2251a and the first magnet 2252a. Additionally, the second lens group 2221b seated on the first lens assembly 2222a may also move in the third direction.

Further, the second lens assembly 2222b on which the second magnet 2252b is seated may move in the third direction (Z-axis direction) by the electromagnetic forces F4A and F4B between the second coil 2251b and the second magnet 2252b. Additionally, the third lens group 2221c seated on the second lens assembly 2222b may also move in the third direction.

Accordingly, as described above, the focal length or magnification of the optical system may be changed by moving the second lens group 2221b and the third lens group 2221c. In an example, the magnification may be changed by moving the second lens group 2221b. In other words, zoom may be achieved. Additionally, a focus may be adjusted by moving the third lens group 2221c. In other words, auto-focus may be achieved. With this configuration, the second camera actuator may be a fixed zoom or a continuous zoom.

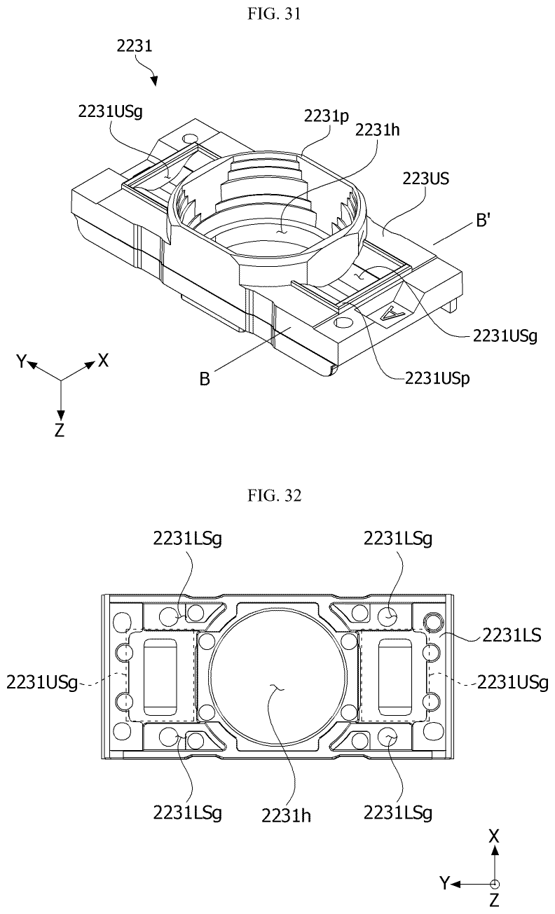

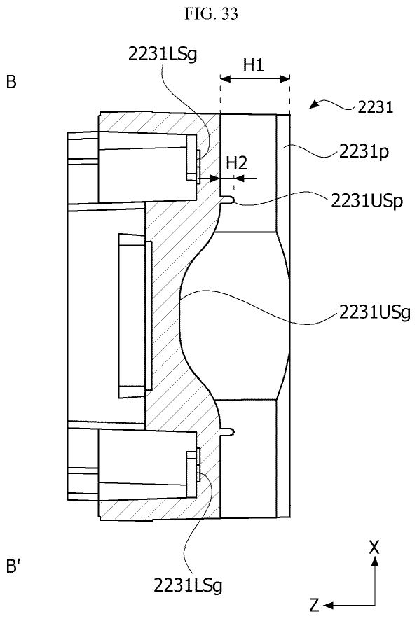

FIG. 31 is a perspective view of the fixed assembly in the second camera actuator according to the embodiment, FIG. 32 is a bottom view of the fixed assembly in the second camera actuator according to the embodiment, and FIG. 33 is a cross-sectional view along line BB′ in FIG. 31.

Referring to FIGS. 31 to 33, in the second camera actuator according to the embodiment, the fixed assembly 2231 may be located between the first camera actuator and the 2-2 housing (hereinafter referred to as a housing) described above. The fixed assembly 2231 may come into contact with the first camera actuator. Furthermore, the first lens assembly may be located between the fixed assembly and the second lens assembly.

In an embodiment, the fixed assembly 2231 may include an assembly hole 2231h, an upper surface groove 2231USg, and a lower surface groove 2231LSg.

The assembly hole 223 1h may be positioned to overlap or correspond to the optical member of the first camera actuator in the optical axis direction. The first lens group may be located in the assembly hole 2231h. Additionally, the assembly hole 2231h may be located in the middle of the fixed assembly 2231.

The fixed assembly 2231 may include an upper surface 2231US and a bottom surface 2231LS. The upper surface 2231US of the fixed assembly 2231 may face the first camera actuator. The bottom surface 2231LS of the fixed assembly 2231 may face the first lens assembly.

Additionally, the fixed assembly 2231 may include a fixed protrusion portion 2231p protruding from the upper surface 2231US toward the outside or the first camera actuator. The fixed protrusion portion 2231p may extend in the opposite direction to the optical axis from the upper surface 2231US.

The assembly hole 2231h may pass through the fixed protrusion portion 2231p.

The upper surface groove 2231USg may be located in the upper surface 2231US of the fixed assembly 2231. The upper surface groove 2231USg may be positioned adjacent to the assembly hole 2231h. Additionally, the upper surface groove 2231USg may be positioned adjacent to the fixed protrusion portion 2231p.

The lower surface groove 2231LSg may be located in the lower surface 2231LS of the fixed assembly 2231. The lower surface groove 2231LSg may be positioned adjacent to the upper surface groove 2231USg. However, the lower surface groove 2231LSg and the upper surface groove 2231USg may be located on opposing surfaces.

The upper surface groove 2231USg may overlap the assembly hole 2231h in the horizontal direction or the second direction (Y-axis direction). Further, the lower surface groove 2231LSg may at least partially overlap the assembly hole 2231h in the horizontal direction or the second direction (Y-axis direction).

The upper surface groove 2231USg may not overlap the lower surface groove 2231LSg in the optical axis direction. The upper surface groove 2231USg may be positioned offset from the lower surface groove 2231LSg in the optical axis direction.

Furthermore, the upper surface groove 2231USg may not overlap the lower surface groove 2231LSg in the horizontal direction or the second direction (Y-axis direction). Furthermore, the upper surface groove 2231USg may be positioned offset from the lower surface groove 2231LSg in the horizontal direction or the second direction (Y-axis direction).

The upper surface groove 2231USg may overlap the lower surface groove 2231LSg in the vertical direction or the first direction (X-axis direction).

In addition, the fixed assembly 2231 may include an upper surface jaw portion 2231USp disposed at an edge of the upper surface groove 2231USg. The upper surface jaw portion 2231USp may be disposed along the edge of the upper surface groove 2231USg. A length H2 of the upper surface jaw portion 2231USp may be smaller than a length H21 of the fixed protrusion portion 2231p.

The fixed assembly 2231 according to the embodiment may easily trap foreign matter that is introduced into the second camera actuator from the first camera actuator or the outside through the upper surface groove 2231USg and the upper surface jaw portion 2231USp. For example, a material for a dust trap may be located in or applied to the upper surface groove 2231USg. For example, the material for a dust trap may be made of a viscous material.

In addition, the fixed assembly 2231 may have the lower surface groove 2231LSg disposed in the lower surface 2231LS which is an inner surface of the second camera actuator so that foreign matter (for example, dust) introduced into or generated inside the second camera actuator is easily captured.

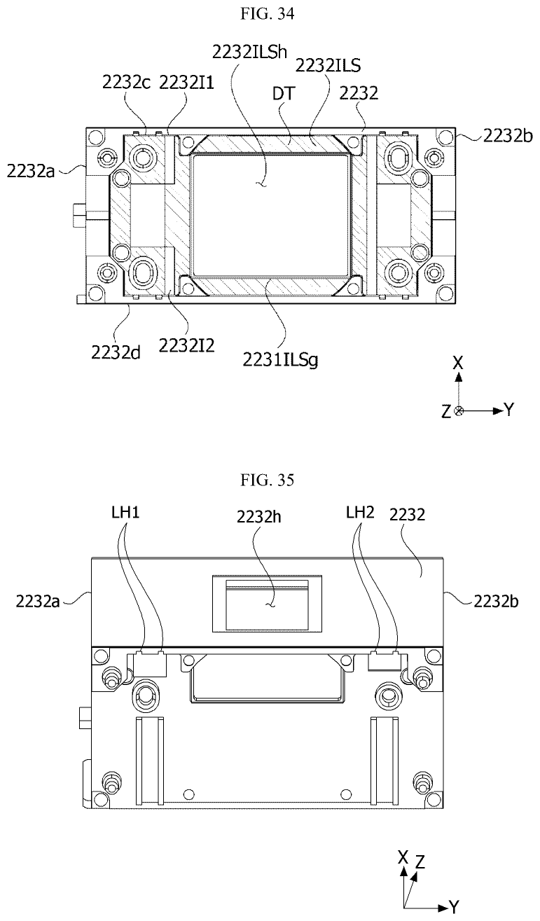

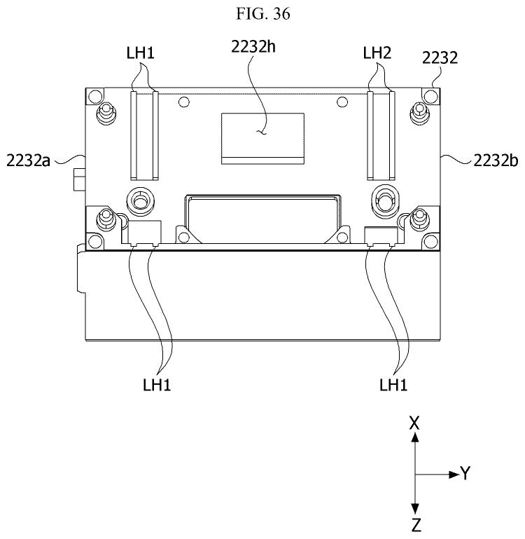

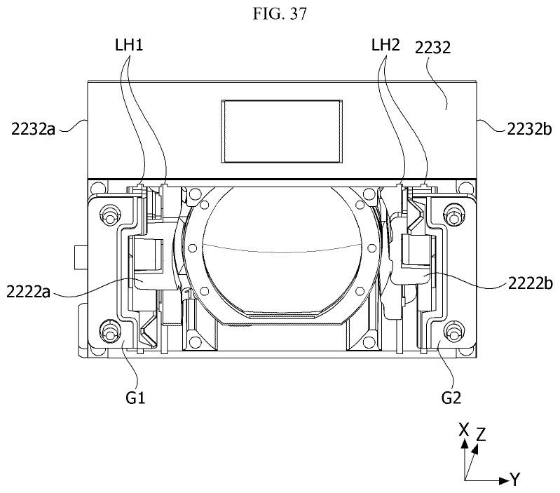

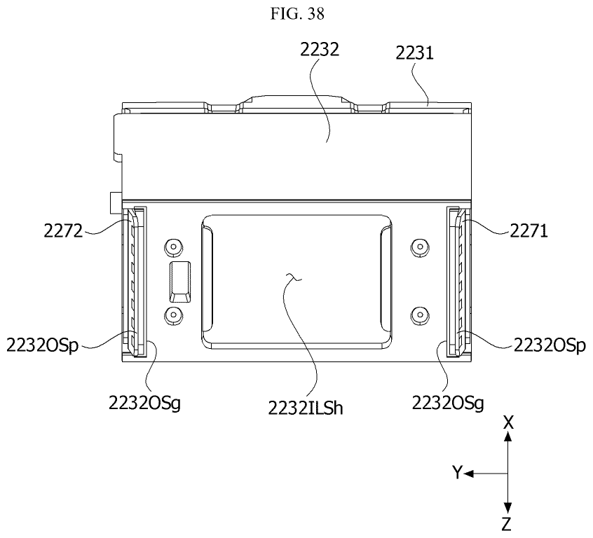

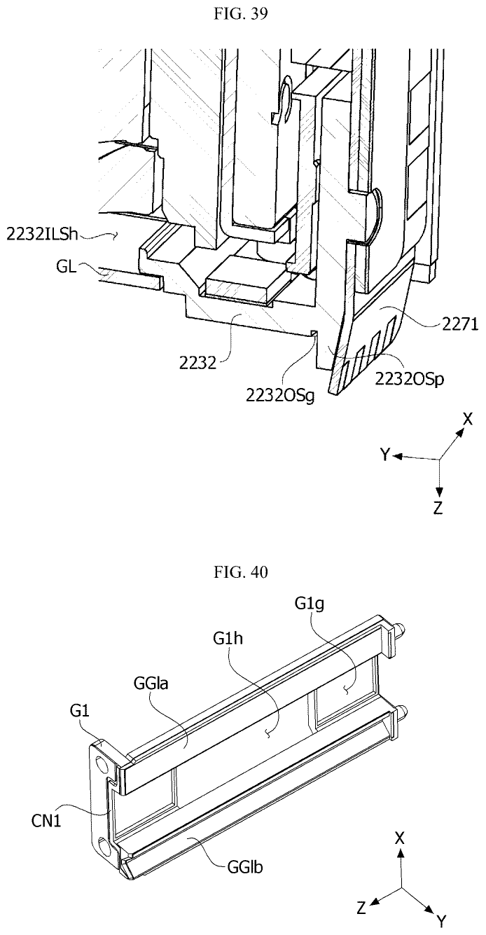

FIG. 34 is a side view of the housing in the second camera actuator according to the embodiment, FIG. 35 is a perspective view of the housing in the second camera actuator according to the embodiment, FIG. 36 is another perspective view of the housing in the second camera actuator according to the embodiment, FIG. 37 is a perspective view of the housing, the lens assembly, the driving unit, and the guide unit in the second camera actuator according to the embodiment, FIG. 38 is a bottom view of the second camera actuator according to the embodiment, and FIG. 39 is an enlarged cross-sectional view of the second camera actuator according to the embodiment.

Referring to FIGS. 34 to 37, in the second camera actuator according to the embodiment, the housing (or lens barrel, hereinafter referred to as a housing) 2232 may include an inner bottom surface 2232ILS having a bottom surface hole 2232ILSh and a trap unit DT disposed on the inner bottom surface 2232ILS. In an embodiment, a layer or member on which the above-described material for a dust trap is located or applied is referred to as a ‘trap unit.’ The trap unit may be disposed at various locations on various elements.

In the second camera actuator according to the embodiment, the housing 2232 may include a third side portion 2232c and a fourth side portion 2232d, in addition to the first side portion 2232a and the second side portion 2232b described above.

The third side portion 2232c and the fourth side portion 2232d may be located between the first side portion 2232a and the second side portion 2232b. Further, the third side portion 2232c and the fourth side portion 2232d may be positioned opposite to each other in the first direction or the vertical direction.

Additionally, the housing 2232 may include a bottom surface jaw portion 2232ILSp disposed adjacent to the bottom surface hole 2232ILSh. The bottom surface hole 2232ILSh may pass through the inner bottom surface 2232ILS of the housing 2232. The inner bottom surface 2232ILS may come into contact with the filter or glass therebelow. The filter or glass may inhibit foreign matter from entering the image sensor disposed at a rear end of the second camera actuator or housing. Alternatively, the filter or glass may filter (remove or band-pass) light of a predetermined wavelength band.

Additionally, the trap unit DT may be located on the inner bottom surface 2232ILS. The trap unit DT may be located at a position other than a region in which a member such as a stopper is disposed. Further, the bottom surface jaw portion 2232ILSp may be located along an edge of the bottom surface hole 2232ILSh. That is, the bottom surface jaw portion 2232ILSp may inhibit foreign matter from entering the bottom surface hole 2232ILSh from the outside of the bottom surface hole 2232ILSh. Furthermore, the bottom surface jaw portion 2232ILSp may inhibit the trap unit DT including a dust solution from being introduced toward the bottom surface hole 2232ILSh. In other words, the deterioration of optical performance may be suppressed by inhibiting the dust solution from being located on the glass or filter.

Furthermore, the housing 2232 may include trap grooves LH1 and LH2 disposed in at least one of inner surfaces thereof facing in the vertical direction. The trap grooves may include a first trap groove LH1 and a second trap groove LH2.

The housing 2232 may include a first inner surface 223211 of the third side portion 2232c and a second inner surface 223212 of the fourth side portion 2232d. The first inner surface 223211 and the second inner surface 223212 may face each other in the vertical direction.

The first trap groove LH1 and the second trap groove LH2 may be located on at least one of the first inner surface 223211 and the second inner surface 223212. Particularly, the first trap groove LH1 and the second trap groove LH2 may be located in a region in which the first trap groove LH1 and the second trap groove LH2 do not overlap the bottom surface hole 2232ILSh of the housing 2232 in the optical axis direction. For example, the first trap groove LH1 and the second trap groove LH2 may be located on an outer side of the bottom surface hole 2232ILSh of the housing 2232.

Furthermore, as described above, the second camera actuator may include guide units G1 and G2 disposed adjacent to the side portions of the housing 2232. The guide unit may include a first guide unit G1 and a second guide unit G2. The first guide unit G1 may be positioned adjacent to the first side portion. The second guide unit G2 may be positioned adjacent to the second side portion.

A plurality of trap grooves may be provided. For example, each of the first trap groove LH1 and the second trap groove LH2 may include a plurality of trap grooves. For example, the first trap groove LH1 may include a plurality of trap grooves. Further, the second trap groove LH2 may include a plurality of trap grooves.

Further, any one of the plurality of trap grooves may overlap the guide unit in the vertical direction (or the first direction (X-axis direction)).

Furthermore, another one of the plurality of trap grooves may overlap any one of the first lens assembly and the second lens assembly in the vertical direction (X-axis direction).

For example, a part of the first trap grooves LH1 may overlap the first guide unit G1 in the vertical direction, and another part may overlap the first lens assembly 2222a (or the first magnet) in the vertical direction.

Further, a part of the second trap grooves LH2 may overlap the second guide unit G2 in the vertical direction, and another part may overlap the second lens assembly 2222b (or the second magnet) in the vertical direction.

With this configuration, foreign matter (for example, dust) generated by the movement of the first lens assembly and the second lens assembly by the driving unit can be captured by the dust solution applied in the trap groove. In this way, the foreign matter does not become a problem and the stain defect issue of the image sensor may be inhibited.

Referring further to FIGS. 38 and 39, the second camera actuator may include the board units 2271 and 2272 disposed on the side portions of the housing 2232. The board units may include the first board 2271 and the second board 2272. For example, the first board 2271 may be located on the first side portion. The second board 2272 may be located on the second side portion.

Further, the housing 2232 may include outer surface protrusions 2232OSp that protrude in the optical axis direction (Z-axis direction) and come into contact with the board units.

The outer surface protrusions 2232OSp may be located on an outer surface 2232OS of the housing 2232.

Further, the outer surface 2232OS of the housing 2232 may include outer surface grooves 2232OSg disposed adjacent to the outer surface protrusions 2232OSp.

The outer surface protrusions 2232OSp may be located on an inner side of the first board and the second board. The outer surface protrusions 2232OSp may support the first board and the second board that are bent inward or outward. For example, the first board and the second board may be bent inward or toward the bottom surface hole 2232ILSh in the optical axis direction.

The outer surface protrusions 2232OSp may support the first board and the second board. In this way, the reliability of the board unit may be improved.

In addition, the outer surface protrusions 2232OSp may inhibit the inflow of foreign matter from the outside to the inside. Furthermore, the outer surface grooves 2232OSg may be disposed along edges of the outer surface protrusions 2232OSp. The outer surface grooves 2232OSg may be located on an inner side of the outer surface protrusions 2232OSp. Further, the outer surface grooves 2232OSg may surround the outer surface protrusions 2232OSp.

Further, a solution or the like for capturing foreign matter (or particles) as the above-described dust trap unit may be located or applied in the outer surface grooves 2232OSg. In addition, the solution applied through the outer surface grooves 2232OSg may not flow into the bottom surface hole 2232ILSh. That is, the applied solution may not be disposed on the optical path received by the image sensor. The plurality of outer surface grooves 2232OSg may be disposed spaced apart from each other in the second direction. Further, the bottom surface hole 2232ILSh may be located between the plurality of outer surface grooves 2232OSg. The plurality of outer surface grooves 2232OSg and the bottom surface hole 2232ILSh may overlap in the second direction or the horizontal direction.

Additionally, the outer surface grooves 2232OSg may be located on the inner side of the outer surface protrusions 2232OSp and the first board 2271. Additionally, for electrical connection, the first board 2271 may have a structure that extends further in the optical axis than the outer surface protrusions 2232OSp.

Furthermore, the outer surface grooves 2232OS may be located at the outermost side on the outer surface. That is, the outer surface grooves 2232OS may be disposed spaced apart from the bottom surface hole 2232ILSh in the second direction. Furthermore, the filter or glass GL may be located in the bottom hole 2232ILSh as described above. With this configuration, the bottom surface groove 2232ILSh can capture foreign matter outside so that the introduction of foreign matter into the optical path is minimized.

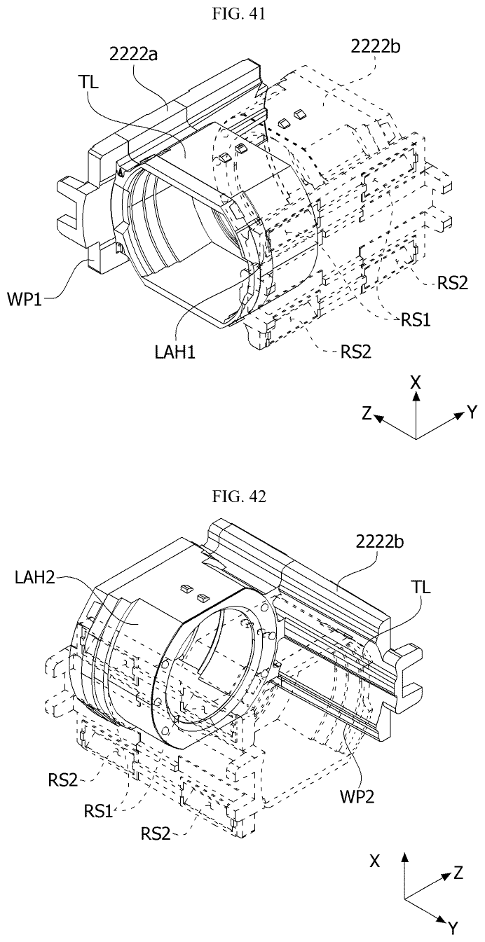

FIG. 40 is a perspective view of the guide unit of the second camera actuator according to the embodiment, FIG. 41 is a perspective view of the first lens assembly and the second lens assembly in the second camera actuator according to the embodiment, and FIG. 42 is another perspective view of the first lens assembly and the second lens assembly in the second camera actuator according to the embodiment.

Referring to FIG. 40, the second camera actuator according to the embodiment may include the guide unit as described above. The guide unit may include a first guide unit and a second guide unit. The following description is made based on a first guide unit G1, but may be equally applied to the second guide unit.

The first guide unit G1 may include a first guide groove GG1a and a second guide groove GG1b in which balls are seated.

Further, the first guide unit G1 may include a connecting portion CN1 that connects the first guide groove GG1a and the second guide groove GG1b. An inner surface of the connecting portion CN1 may have a step with the first guide groove GG1a and the second guide groove GG1b. For example, the inner surface of the connecting portion CN1 may be located on an outer side of the first guide groove GG1a and the second guide groove GG1b. With this configuration, even when the first ball and the second ball are seated in the first guide groove GG1a and the second guide groove GG1b, the movement of the first lens assembly can be easily achieved. That is, the movement of the first lens assembly may not be impeded by the connecting portion CN1.

Furthermore, a guide recess G1g may be located in an inner surface of the connecting portion CN1. That is, the connecting portion CN1 may include the guide recess G1g disposed in the inner surface. The guide recess G1g may be located on an outer side of the first guide groove GG1a and the second guide groove GG1b. Further, a dust solution may be located in the guide recess G1g. With this configuration, foreign matter or particles generated in the first guide groove GG1a and the second guide groove GG1b by the first ball and the second ball may be captured by the guide recess G1g.

In other words, particles or foreign matter generated by zooming or AF in the second camera actuator may not be located on the glass or filter or may not be introduced into the image sensor.

Referring further to FIGS. 41 and 42, in the second camera actuator according to the embodiment, the first lens assembly 2222a may include a first lens holder LAH1 and a first wing portion WP1. A lens may be accommodated in the first lens holder LAH1. For example, the second lens group may be located in the first lens holder LAH1.

Further, a trap unit TL may be located on an inner surface of the first wing portion WP1. In other words, a groove (wing portion groove) may be located in the inner surface of the first wing portion WP1. Further, a dust solution may be located in the wing portion groove. With this configuration, particles (foreign matter) generated by external foreign matter or driving can be inhibited from being introduced into the second lens group of the first lens holder LAH1. That is, foreign matter or particles may not be located in the optical path or the effective region of the lens.

Similarly, the second lens assembly 2222b may include a second lens holder LAH2 and a second wing portion WP2. A lens may be accommodated in the second lens holder LAH2. For example, the third lens group may be located in the second lens holder LAH2.

Further, the trap unit TL may be located on an inner surface of the second wing portion WP2. In other words, a groove (wing portion groove) may be located in the inner surface of the second wing portion WP2. Further, a dust solution may be located in the wing portion groove. With this configuration, particles (foreign matter) generated by external foreign matter or driving can be inhibited from being introduced into the third lens group of the second lens holder LAH2. That is, foreign matter or particles may not be located in the optical path or the effective region of the lens.

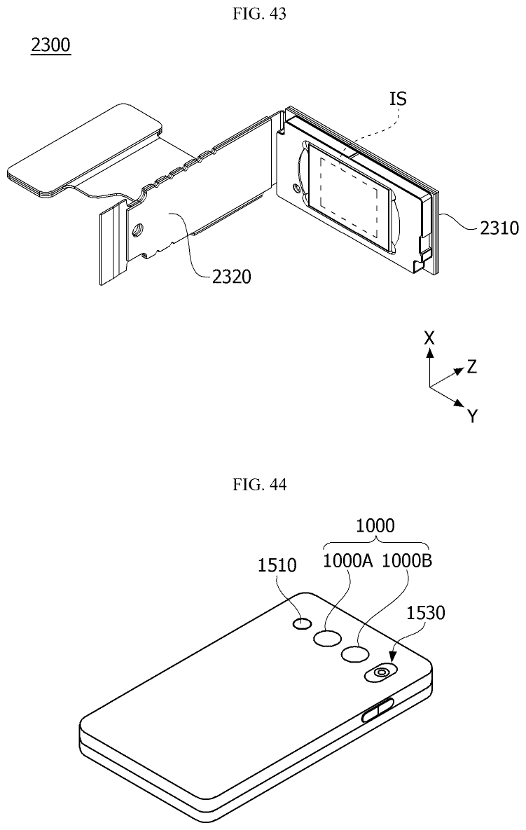

FIG. 43 is a schematic view showing a circuit board according to an embodiment.

Referring to FIG. 43, as described above, a circuit board 2300 according to the embodiment may include a first circuit board unit 2310 and a second circuit board unit 2320. The first circuit board unit 2310 may be located below a base and coupled to the base. Furthermore, an image sensor IS may be disposed on the first circuit board unit 2310. Further, the first circuit board unit 2310 and the image sensor IS may be electrically connected. That is, the base may be located at a rear end of the second camera actuator, and the image sensor and the circuit board (first circuit board unit) may be located at a rear end of the base. The base may include a filter (for example, an infrared filter or the like). The circuit board 2300 may include the image sensor and the sensor base described above.

Also, the second circuit board unit 2320 may be located on a side portion of the base. Particularly, the second circuit board unit 2320 may be located on a first side portion of the base. Accordingly, the second circuit board unit 2320 may be positioned adjacent to a first coil positioned adjacent to the first side portion to facilitate electrical connection. Additionally, the second circuit board unit 2320 may be located on a second side portion. In this way, a plurality of second circuit board units 2320 may be provided. However, the present invention is not limited thereto and the second circuit board unit 2320 may be disposed on only one of the first side portion and the second side portion.

Furthermore, the circuit board 2300 may additionally include a fixed board (not shown) located on a side surface thereof. Thus, even when the circuit board 2300 is made of a flexible material, the circuit board 2300 may be coupled to the base while maintaining rigidity due to the fixed board.

The second circuit board unit 2320 of the circuit board 2300 may be located on a side portion of the driving unit 2250. The circuit board 2300 may be electrically connected to a first driving unit and a driving unit. For example, electrical connection may be made using SMT. However, the present invention is not limited to this method.

The circuit board 2300 may include a circuit board having electrically connectable wiring patterns, such as a rigid printed circuit board (rigid PCB), a flexible printed circuit board (flexible PCB), and a rigid flexible printed circuit board (rigid flexible PCB). However, the present invention is not limited to these types.

Additionally, the circuit board 2300 may be electrically connected to another camera module in a terminal or to a processor of the terminal. Through this, the above-described camera actuator and the camera module including the same may transmit and receive various signals in the terminal.

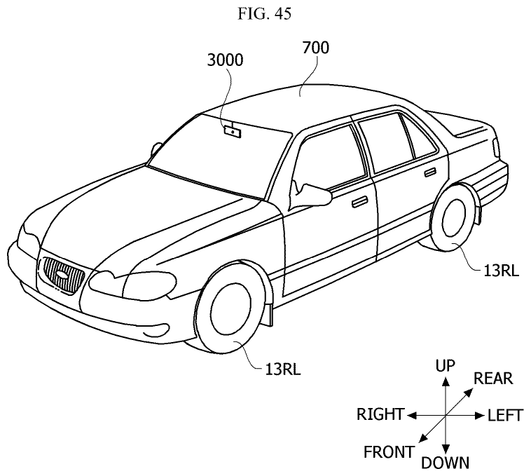

FIG. 44 is a perspective view of a mobile terminal to which the camera module according to the embodiment is applied.

As shown in FIG. 44, a mobile terminal 1500 in the embodiment may include a camera module 1000, a flash module 1530, and an auto-focus device 1510 provided on a rear surface thereof.

The camera module 1000 (or camera module 2000) may include an image capturing function and an auto-focus function. For example, the camera module 1000 may include an auto-focus function using an image.

The camera module 1000 processes image frames of still or moving images obtained by an image sensor in a capturing mode or a video call mode.

The processed image frames may be displayed on a predetermined display unit and stored in a memory. A camera (not shown) may also be disposed on the front of a body of a mobile terminal.

For example, the camera module 1000 may include a first camera module 1000A and a second camera module 1000B, and OIS along with an AF or zoom function may be implemented by the first camera module 1000A.

The flash module 1530 may include a light-emitting element that emits light therein. The flash module 1530 may be operated by the operation of the camera of the mobile terminal or through the user's control.

The auto-focus device 1510 may include one of packages of surface-light-emitting laser devices as a light-emitting unit.

The auto-focus device 1510 may include an auto-focus function using a laser. The auto-focus device 1510 may be mainly used in conditions where it is difficult to use the auto-focus function using the image of the camera module 1000, for example, in a close range of 10 m or less or in a dark environment.

The auto-focus device 1510 may include a light emitting unit including a vertical cavity surface emitting laser (VCSEL) semiconductor device and a light receiving unit that converts light energy into electrical energy, such as a photodiode.

FIG. 45 is a perspective view of a vehicle to which the camera module according to the embodiment is applied.

For example, FIG. 45 is an exterior view of the vehicle including a vehicle driving assistance device to which the camera module 1000 (or camera module 2000) according to the embodiment is applied.

Referring to FIG. 45, a vehicle 700 in the embodiment may include wheels 13FL and 13FR that rotate by a power source and a predetermined sensor. The sensor may be, but is not limited to, a camera sensor 3000.

The camera sensor 3000 may be a camera sensor to which the camera module 1000 according to the embodiment is applied. The vehicle 700 in the embodiment may obtain image information through the camera sensor 3000 that captures a front image or a surrounding image and use the image information to determine a lane non-identification situation and create a virtual lane when the lane is not identified.

For example, the camera sensor 3000 may capture the front of the vehicle 700 to obtain the front image and the processor (not shown) may analyze objects included in the front image to obtain image information.

For example, when objects such as lanes, adjacent vehicles, traffic obstructions, and center dividers, curbs, and street trees which correspond to indirect road markings are captured in the image captured by the camera sensor 3000, the processor may detect these objects and include information regarding these objects in the image information. At this time, the processor may obtain distance information to an object detected through the camera sensor 3000 to further supplement the image information.

The image information may be information regarding an object captured in an image. The camera sensor 3000 may include an image sensor and an image processing module.

The camera sensor 3000 may process still images or moving images obtained by an image sensor (for example, a CMOS or a CCD).

The image processing module may process still images or moving images obtained through an image sensor, extract necessary information, and transmit the extracted information to the processor.

At this time, although the camera sensor 3000 may include a stereo camera to improve the measurement accuracy of the object and secure more information such as the distance between the vehicle 700 and the object, the present invention is not limited thereto.

Although the embodiments have been mainly described above, these are merely examples and are not intended to limit the present invention, and it can be seen by those skilled in the art that various modifications and applications not exemplified herein are possible without departing from the essential characteristics of the present invention. For example, each of the components specifically shown in the embodiments may be modified and implemented. Further, it should be interpreted that differences related to the modifications and the applications are included in the scope of the present invention defined by the appended claims.

1. A camera actuator comprising:
a housing;
a mover disposed in the housing and including a holder and an optical member disposed in the holder;
a driving unit configured to move the mover;
a coupling member that passes through the housing and is coupled to the holder;
a tilting guide unit disposed between the housing and the mover to guide tilting of the mover; and
an elastic member disposed between the coupling member and the housing,
wherein the elastic member presses the tilting guide unit to the mover.

2. The camera actuator of claim 1, wherein the mover is rotatable in at least one of a first direction and a second direction.

3. The camera actuator of claim 2, wherein the coupling member includes a member base portion, a first extension portion extending from one end of the member base portion toward the holder, and a second extension portion extending from an other end of the member base portion toward the holder.

4. The camera actuator of claim 3, wherein the coupling member includes a first groove disposed in an inner surface of the member base portion.

5. The camera actuator of claim 4, wherein the housing includes a housing side portion facing the member base portion, and
the housing side portion includes a first through hole and a second through hole.

6. The camera actuator of claim 5, wherein the first extension portion passes through the first through hole, and
the second extension portion passes through the second through hole.

7. The camera actuator of claim 5, wherein the first groove is disposed between the first through hole and the second through hole, and overlaps the first through hole and the second through hole in the second direction.

8. The camera actuator of claim 6, wherein the elastic member includes a first elastic member and a second elastic member disposed spaced apart from each other in the second direction, and
the first elastic member and the second elastic member are disposed between the first through hole and the second through hole.

9. The camera actuator of claim 4, wherein the housing side portion includes a second groove facing the first groove, and
the elastic member is disposed in the first groove and the second groove.

10. The camera actuator of claim 9, wherein the second groove overlaps the first groove in a third direction perpendicular to the first direction and the second direction.

11. The camera actuator of claim 9, wherein the first groove is partially offset from the second groove in the third direction perpendicular to the first direction and the second direction.

12. The camera actuator of claim 9, wherein the first groove is located below a line bisecting the coupling member in the first direction.

13. The camera actuator of claim 9, wherein the first groove overlaps a line bisecting the coupling member in the first direction.

14. The camera actuator of claim 9, wherein the tilting guide unit includes a base, a first protruding portion spaced apart in the first direction on one surface of the base, and a second protruding portion spaced apart in the second direction on an other surface of the base.

15. The camera actuator of claim 14, wherein the first groove and the second groove overlap the second protruding portion in the third direction.

16. The camera actuator of claim 14, wherein the first protruding portion protrudes from the base toward the mover, and the second protruding portion protrudes toward the housing side portion.

17. The camera actuator of claim 14, comprising:
a plate;
wherein the plate is disposed on an outside of the coupling member where the elastic member is not disposed.

18. The camera actuator of claim 17, wherein the plate is made of a magnetic material.

19. The camera actuator of claim 1,
wherein the housing includes an accommodating portion, and
wherein the holder is seated in the accommodating portion of the housing.

20. The camera actuator of claim 1,
wherein the elastic member is seated in a first groove formed in the coupling member and in a second groove formed in the housing.
